(19) United States
(12) Patent Application Publication
(10) Pub. No.: US 2024/0182316 A1
(43) Pub. Date: Jun. 6, 2024

(54) METHOD FOR PRODUCING LITHIUM COMPOUND AND APPARATUS FOR PRODUCING LITHIUM COMPOUND

(71) Applicant: IDEMITSU KOSAN CO.,LTD., Chiyoda-ku (JP)

(72) Inventors: Hideki YAMAMOTO, Izumiotsu-shi (JP); Futoshi UTSUNO, Ichihara-shi (JP); Daisuke MORI, Chiba-shi (JP); Hiroyuki HIGUCHI, Sodegaura-shi (JP)

(73) Assignee: IDEMITSU KOSAN CO.,LTD., Chiyoda-ku (JP)

(21) Appl. No.: 18/553,099

(22) PCT Filed: Apr. 1, 2022
(86) PCT No.: PCT/JP2022/017005

§ 371 Date: Sep. 28, 2023

(30) Foreign Application Priority Data
Apr. 1, 2021 (JP) 2021-063165

(51) Int. Cl. C01D 15/02; B01D 9/00; B01D 61/44; B01J 19/24; C01D 15/08; C25B 3/07; C25B 15/08

(52) U.S. Cl. CPC C01D 15/02; B01D 9/0018; B01D 61/44; B01J 19/245; C01D 15/08; C25B 3/07; C25B 15/08; B01D 2009/0086

(57) ABSTRACT

A method for producing a lithium compound, by which a high purity lithium compound can be produced from low-grade lithium carbonate containing impurities, such as salt water. The method includes: mixing lithium carbonate, an acid containing an organic acid, and water in a reaction tank 1 to produce an aqueous organic acid lithium solution containing an organic acid lithium; mixing the organic acid lithium and a metal hydroxide in a reaction tank 2 to produce an aqueous lithium hydroxide solution; and returning an organic acid, which is regenerated by using an electrochemical device from an organic acid metal by-produced by producing the aqueous lithium hydroxide solution to the reaction tank 1 and using the regenerated organic acid as the organic acid. An apparatus for producing a lithium compound, including the reaction tank 1, the reaction tank 2, the electrochemical device, and a return pipe, which each have a specific function.

### TECHNICAL FIELD

The present invention relates to a method for producing a lithium compound and an apparatus for producing a lithium compound.

### BACKGROUND ART

With a rapid spread of information-related devices, communication devices and the like such as personal computers, video cameras, and mobile phones in recent years, development of batteries used as power sources for these devices has been regarded as important. Conventionally, an electrolytic solution containing a combustible organic solvent has been used for a battery used for such an application; however, a battery in which the electrolytic solution is replaced with a solid electrolyte layer has been developed since, by making the battery into an all-solid state, the combustible organic solvent is not used in the battery, a safety device can be simplified, and a production cost and productivity are excellent.

Lithium secondary batteries and the like are used as batteries for use in the applications described above, and in recent years, use for hybrid cars and electric vehicles that are developed to cope with carbon dioxide gas emission regulations has also been studied. As a solid electrolyte for use in lithium secondary batteries and others, known is a sulfide solid electrolyte. A sulfide solid electrolyte has a high ionic conductivity, and is therefore useful for high-power batteries. For producing a sulfide solid electrolyte, lithium sulfide is used widely as a raw material, and thus a demand for lithium hydroxide to be a raw material is increasing as a demand for lithium sulfide increases. As a lithium hydroxide production method, there exists a method of electrolyzing an aqueous solution or a suspension of lithium carbonate to produce an aqueous solution of lithium hydroxide via an ion exchange membrane (for example, see PTL 1). In addition, as a method for producing lithium hydroxide, a method including a step of reacting lithium carbonate with an acid containing acetic acid to produce lithium acetate and a step of reacting lithium acetate with a metal hydroxide to produce lithium hydroxide has been proposed (see, for example, PTL 2).

Also, as mentioned above, the use for hybrid cars and electric vehicles has been studied, and when this is put into practical use, it will be necessary to secure lithium in a more stable manner. In order to seek a broader range of lithium sources, a technique of recovering lithium from salt water of a salt lake using a manganese oxide compound as an adsorbent (see, for example, NPLs 1 and 2), a technique of recovering lithium by solar evaporation of salt water (see, for example, NPLs 1 and 3), and the like have been disclosed.

### CITATION LIST

### Patent Literature

PTL 1: JP 2009-270188 A
PTL 2: JP 2019-131448 A

### Non Patent Literature

NPL 1: “2008 Technical Support Project for Field Needs—Joint Study Report on the Development of Lithium Recovery System from Salt Water (Public Version)” (Japan Oil, Gas and Metals National Corporation (JOGMEC), Mitsubishi Corporation), March 2010, p. 31 to 32
NPL 2: Journal of MMIJ, 2019, Vol. 135, No. 9
NPL 3: “Overview of Lithium Production Technology—Current Status and Future Trends”, Metal Resources Report, Mar. 29, 2019, 19-03-Vol. 48

### SUMMARY OF INVENTION

### Technical Problem

When lithium hydroxide is obtained by the technique described in Patent Document 1, etc., a dehydration step such as heating and concentration is required. As a result, a large amount of energy is consumed, and in order to obtain lithium at a lower cost, it is necessary to reduce required energy. In the method described in PTL 2, although acetic acid is mainly used as an acid in the reaction with lithium carbonate, regarding the handling of potassium acetate and sodium acetate, which are by-produced in a process of producing lithium hydroxide, it is said that potassium acetate can be used as an antifreeze solution, etc., and therefore has industrial utility value. However, there is no proposal to reuse by-products such as potassium acetate and sodium acetate in the method for producing lithium hydroxide, lacking the viewpoint of efficiently producing a lithium compound, and there is room for significant improvement in production efficiency.

In addition, while the demand for lithium used in solid electrolytes is expected to expand, in order to seek a broader range of lithium sources, it is necessary to cope with low-grade lithium sources containing impurities obtained from a wide range of aqueous solutions such as salt water and geothermal water as disclosed in Non Patent Literatures 1 to 3. However, in the technique described in Patent Literature 1 and the like, there is a problem that when trying to use a low-grade lithium source, electrolysis using an ion exchange membrane needs to consume a large amount of energy. Solving these problems is extremely important in the process of meeting the growing demand for lithium and promoting industrialization. Similarly, it is also extremely important to improve the production efficiency of the lithium compound in the method described in Patent Literature 2.

The present invention has been made in view of such circumstances, and an object thereof is to provide a lithium compound production method and a lithium compound production apparatus capable of efficiently producing a high-purity lithium compound from low-grade lithium carbonate containing impurities such as salt water.

### Solution to Problem

The lithium compound production method according to the present invention is a method for producing a lithium compound, including mixing lithium carbonate, an acid containing an organic acid, and water in a reaction tank 1 to produce an aqueous organic acid lithium solution containing an organic acid lithium, mixing the aqueous organic acid lithium solution and a metal hydroxide in a reaction tank 2 to produce an aqueous lithium hydroxide solution, and returning an organic acid, which is regenerated by using an electrochemical device from an organic acid metal by-produced by producing the aqueous lithium hydroxide solution, to the reaction tank 1 and using the regenerated organic acid as the organic acid.

Further, the lithium compound production apparatus according to the present invention is an apparatus for producing a lithium compound, including a reaction tank 1, a reaction tank 2, an electrochemical device, and a return pipe, wherein the reaction tank 1 is a tank for mixing lithium carbonate, an acid containing an organic acid, and water to produce an aqueous organic acid lithium solution, the reaction tank 2 is a tank for mixing the aqueous organic acid lithium solution and a metal hydroxide to produce an aqueous lithium hydroxide solution, the electrochemical device is a device for regenerating an organic acid used in producing the aqueous organic acid lithium solution from an aqueous solution obtained by removing lithium hydroxide from the aqueous lithium hydroxide solution, and the return pipe is a pipe for returning the regenerated organic acid to the reaction tank 1.

### Advantageous Effects of Invention

According to the present invention, a lithium compound production method and a lithium compound production apparatus capable of efficiently producing a high-purity lithium compound from low-grade lithium carbonate containing impurities such as salt water, can be provided.

### BRIEF DESCRIPTION OF DRAWINGS

FIG. 1 is a flowchart showing a preferred embodiment of a lithium compound production apparatus capable of carrying out a lithium compound production method of the present embodiment.

FIG. 2 is a flowchart showing a preferred embodiment of a lithium compound production apparatus capable of carrying out a lithium compound production method of the present embodiment.

FIG. 3 is a flowchart showing a preferred embodiment of a lithium compound production apparatus capable of carrying out a lithium compound production method of the present embodiment.

FIG. 4 is a flowchart showing a preferred embodiment of a lithium compound production apparatus capable of carrying out a lithium compound production method of the present embodiment.

FIG. 5 is a schematic view showing a preferred embodiment of an electrochemical device.

### DESCRIPTION OF EMBODIMENTS

Hereinafter, a lithium compound production method and a lithium compound production apparatus of one embodiment of the present invention (hereinafter referred to as “the present embodiment”) will be described below: The lithium compound production method and the lithium compound production apparatus of one embodiment of the present invention are merely one embodiment for the lithium compound production method and the lithium compound production apparatus of the present invention, and the present invention is not limited to the lithium compound production method and the lithium compound production apparatus of one embodiment of the present invention. In the present description, lithium means both lithium and lithium ions, and should be interpreted as appropriate as long as technical contradiction does not occur.

In the description herein, the numerical values of the upper limit and the lower limit related to the numerical ranges of “X or more” and “Y or less”, and “X to Y” are numerical values that can be arbitrarily combined, and the numerical values of the Examples can also be used as the numerical values of the upper limit and the lower limit. For example, when a numerical range is described as “A to B” and “C to D”, numerical ranges such as “A to D” and “C to B” are also included. The same applies to the terms “X or more” and “Y or less”.

### (Findings Obtained by the Inventor to Arrive at the Present Invention)

As a result of intensive studies to solve the above-mentioned problems, the present inventors have found the following matters and completed the present invention.

As described in PTL 1, conventionally, there has been a production method of converting an aqueous solution of lithium carbonate or the like into an aqueous solution of lithium hydroxide using an electrochemical device using an ion exchange resin. However, in the method, although anions such as carbonate ions and sulfate ions can be removed by the ion exchange resin, the selectivity of metal ions is not high. Therefore, in order to obtain a high-purity lithium compound, there is a problem that a pretreatment step is required to sufficiently remove metal impurities.

By the way, the present inventors focused on a reaction in which lithium carbonate, an organic acid such as acetic acid, and water are mixed to produce an organic acid lithium, and a reaction in which an aqueous organic acid lithium solution is mixed with a metal hydroxide to produce lithium hydroxide.

Regarding the reaction that produces lithium hydroxide, for example, it is possible to focus on a reaction that produces lithium hydroxide by mixing lithium carbonate and calcium hydroxide. However, the reactivity between lithium carbonate and calcium hydroxide is not high, and heating is required to promote the reaction. Moreover, due to the relationship with calcium hydroxide, it takes time to dissolve lithium carbonate, and it is necessary to use a large amount of water. In this regard, in the present invention, since the solubility of lithium carbonate is improved by adopting the reaction using an organic acid such as acetic acid, the amount of water used can be reduced. Reducing the amount of water used leads to increased efficiency of the production method as a whole. The reaction using an organic acid such as acetic acid is highly reactive and does not require heating to promote the reaction, and thus is more advantageous than the reaction between lithium carbonate and calcium hydroxide.

In addition, in the present invention, lithium hydroxide is produced by mixing organic acid lithium and a metal oxide, and the aqueous solution after recovering the lithium hydroxide contains an organic acid metal. By regenerating the organic acid from the organic acid metal, the organic acid can be reused for the reaction with lithium carbonate. In regenerating an organic acid from an organic acid metal, the employment of an electrochemical device has been studied. An electrochemical device using an ion exchange membrane is also employed in the method of PTL 1. However, as in PTL 1, in the case of converting lithium carbonate to lithium hydroxide using an electrochemical device, when low-grade lithium carbonate is used as a raw material, the concentration of lithium carbonate is low; and thus a large amount of energy is required to obtain lithium hydroxide. In this regard, in the present invention, the content of the organic acid metal is high, and thus energy consumption can be reduced.

By adopting the above reaction using an organic acid such as acetic acid, it is possible to reduce the energy consumption required for heating and depressurization, as well as the energy consumption in the electrochemical device. In addition, since the amount of water used is also reduced, it is thought that a high-purity lithium compound can be efficiently produced from low-grade lithium carbonate containing metals other than lithium as impurities, such as salt water.

The present inventors have made the present invention based on the above findings.

### VARIOUS FORMS OF THE PRESENT EMBODIMENT

The method for producing a lithium compound according to a first form of the present embodiment is a lithium compound production method including
mixing lithium carbonate, an acid containing an organic acid, and water in a reaction tank 1 to produce an aqueous organic acid lithium solution containing an organic acid lithium,
mixing the aqueous organic acid lithium solution and a metal hydroxide in a reaction tank 2 to produce an aqueous lithium hydroxide solution, and
returning an organic acid, which is regenerated by using an electrochemical device from an organic acid metal by-produced by producing the aqueous lithium hydroxide solution, to the reaction tank 1 and using the regenerated organic acid as the organic acid.

As described above, the invention relating to the method for producing a lithium compound of the present embodiment focuses on two reactions, that is, the reaction of producing organic acid lithium by mixing lithium carbonate, an acid containing an organic acid such as acetic acid, and water, and the reaction of producing lithium hydroxide by mixing an aqueous organic acid lithium solution with a metal hydroxide. An aqueous solution of an organic acid such as acetic acid has high solubility with lithium carbonate and high reactivity, and thus the reaction proceeds rapidly even without heating. Further, since the aqueous solution of organic acid lithium obtained by the reaction has high reactivity with the metal hydroxide, lithium hydroxide can be easily produced. Moreover, in these reactions, since the solubility of lithium carbonate is high, the amount of water used when forming an aqueous solution can be reduced, and the efficiency of the production method as a whole is improved.

Further, the aqueous solution after the reaction for producing the lithium hydroxide is performed and the lithium hydroxide is recovered contains an organic acid metal. The aqueous solution containing the organic acid metal can be used in an electrochemical device, specifically by supplying the aqueous solution as a catholyte to the electrochemical device, so that an organic acid such as acetic acid can be regenerated, and the organic acid such as acetic acid is used for the reaction with lithium carbonate. In addition, since the aqueous solution obtained by regenerating the organic acid from the aqueous solution containing the organic acid metal contains the metal hydroxide, the aqueous solution containing the metal hydroxide is used for a reaction by mixing with the organic acid lithium.

By forming recycling through an organic acid such as acetic acid in this way, the solution can be reused, and waste can be reduced as much as possible. It can be said that the fact that chemicals of an organic acid, such as acetic acid, and metal hydroxide, etc. can be reduced and waste can be reduced is an advantage of focusing on the reaction by mixing with an aqueous solution using an organic acid such as acetic acid.

Since the production method of the present embodiment employs an electrochemical device, the device consumes energy. However, since the content of the organic acid metal in the aqueous solution containing the organic acid metal to be supplied to the electrochemical device is high, the energy consumption required for recovering the organic acid such as acetic acid from the aqueous solution can be kept low compared to, for example, the case of producing lithium hydroxide from low-grade lithium carbonate using an electrochemical device. Therefore, energy consumption in the electrochemical device can also be reduced.

Thus, according to the method for producing a lithium compound of the present embodiment, while using low-grade lithium carbonate containing impurities such as salt water, by adopting a highly reactive reaction, it is possible to reduce the consumption of energy required for heating and the like, and to reduce the amount of water used. In addition, although an electrochemical device is used, it is possible to reuse a solution and reduce waste as much as possible by achieving recycling via an organic acid such as acetic acid while reducing energy consumption.

A method for producing a lithium compound according to a second form of the present embodiment is a method where, in the first form, the metal hydroxide is regenerated by the electrochemical device and returned to the reaction tank 2.

As described above, by producing lithium hydroxide and supplying the aqueous solution containing the organic acid metal after recovering the lithium hydroxide as the catholyte to the electrochemical device, an organic acid such as acetic acid and a metal hydroxide are regenerated. Therefore, in the production method according to the second form, the metal hydroxide regenerated by the electrochemical device is intended to be used for the reaction with the organic acid lithium. In the production method according to the first form, an organic acid such as acetic acid obtained by regenerating with an electrochemical device is used for a reaction by mixing with lithium carbonate to reduce waste. However, by using a metal hydroxide obtained by regenerating simultaneously with an organic acid such as acetic acid for the reaction with organic acid lithium, it is possible to promote the generation of lithium hydroxide and reduce waste.

A method for producing a lithium compound according to a third form of the present embodiment is a production method including, in the first or second form,
recovering only lithium ions from the aqueous lithium hydroxide solution into a recovery liquid using a lithium ion separation device equipped with a Li permselective membrane.

In the production method of the present embodiment, examples of a method of obtaining high-purity lithium hydroxide from an aqueous lithium hydroxide solution include a method 1 (hereinafter sometimes simply referred to as “method 1”) in which only lithium ions are recovered using a lithium ion separation device equipped with a Li permselective membrane, which will be described later, and a method 2 (hereinafter sometimes simply referred to as “method 2”) through crystallization, solid-liquid separation, redissolution, and impurity removal. From the viewpoint of obtaining high-purity lithium hydroxide more efficiently, a method of recovering only lithium ions using a lithium ion separation device equipped with a Li permselective membrane is preferable.

For example, when the above method 2 is adopted, a method by filtration, a method by heat concentration, a method by pH crystallization, etc. can be adopted for crystallization; however, as described later, the method by pH crystallization is preferable in consideration of efficiency and suppression of energy consumption. On the other hand, when pH crystallization is performed, a chemical such as potassium hydroxide may be used, and thus an increase in the amount of chemical used becomes a problem. In this regard, the method of recovering only lithium ions using a lithium ion separation device equipped with a Li permselective membrane in method 1 is superior in that it does not require the use of chemicals and can obtain high-purity lithium hydroxide.

In addition, when a lithium ion separation device equipped with a Li permselective membrane is used according to method 1, high-purity lithium hydroxide can be obtained by performing crystallization, such as cooling crystallization and evaporative crystallization, on a recovery liquid in which only lithium ions are recovered in the lithium ion separation device, and performing solid-liquid separation. Therefore, method 1 is superior to method 2 in that high-purity lithium hydroxide can be obtained more easily than method 2, which requires, in addition to crystallization and solid-liquid separation, redissolution, impurity removal, and the like to obtain high-purity lithium hydroxide.

A method for producing a lithium compound according to a fourth form of the present embodiment is a production method further including, in the above third form,
crystallizing the recovery liquid recovered using the lithium ion separation device and performing solid-liquid separation 1.

As a result, high-purity lithium hydroxide can be obtained while reducing the amount of chemicals used. In the present description, “purity is high” and “high purity” mean 99% or more in terms of crystal purity.

A method for producing a lithium compound according to a fifth form of the present embodiment is a production method where, in the above third or fourth form,
the organic acid metal is supplied to the electrochemical device by a Li ion-removed aqueous solution obtained by recovering only lithium ions from the aqueous lithium hydroxide solution to the recovery liquid using the lithium ion separation device equipped with a Li permselective membrane.

By the reaction between the organic acid lithium and the metal hydroxide, the organic acid metal is by-produced together with the lithium hydroxide, and an aqueous solution containing the organic acid metal and the lithium hydroxide is obtained. When lithium hydroxide is removed from the aqueous solution containing lithium hydroxide and organic acid metal by recovering only lithium ions using a lithium ion separation device, a Li ion-removed aqueous solution containing organic acid metal is obtained. In the fifth form, in recovering an organic acid from an organic acid metal by-produced by producing an aqueous lithium hydroxide solution using an electrochemical device, the organic acid metal by-produced is supplied as an organic acid metal aqueous solution (Li ion-removed aqueous solution) to the electrochemical device, and an organic acid such as acetic acid is to be recovered from the organic acid metal aqueous solution (Li ion-removed aqueous solution). In the case of method 2, a separated liquid 1 obtained by crystallization and solid-liquid separation 1 from the aqueous solution containing lithium hydroxide and organic acid metal is supplied to the electrochemical device as an organic acid metal aqueous solution.

By reusing the organic acid metal aqueous solution containing the organic acid metal by-produced in the lithium ion separation device (the Li ion-removed aqueous solution or separated solution 1) in this way, waste can be reduced. It can be said that the fact that the organic acid metal aqueous solution (the Li ion-removed aqueous solution or separated solution 1) can be reused is an advantage of focusing on the reaction using an organic acid such as acetic acid.

A method for producing a lithium compound according to a sixth form of the present embodiment is a production method further including, in the above first to fifth forms, adding an oxalic acid to the aqueous organic acid lithium solution and performing solid-liquid separation 4.

By adding an oxalic acid to the aqueous organic acid lithium solution, heavy metals such as calcium and magnesium contained in the low-grade lithium carbonate can be precipitated, and the precipitated heavy metals can be removed by performing the solid-liquid separation 4, so that a separated liquid 4 can be an aqueous organic acid lithium solution with few impurities.

A method for producing a lithium compound according to a seventh form of the present embodiment is a production method where, in the above sixth form, the aqueous lithium hydroxide solution is produced by reacting a separated liquid 4 obtained by the solid-liquid separation 4 with the metal hydroxide.

As described above, in the seventh form, the separated liquid 4 obtained by removing the precipitated heavy metals by the solid-liquid separation 4 is an aqueous organic acid lithium solution with few impurities. By reacting the separated liquid 4 with the metal hydroxide in a reaction tank 2, the purity of lithium hydroxide is improved.

A method for producing a lithium compound according to an eighth form of the present embodiment is a production method further including, in the above third to seventh forms, adding carbon dioxide to the recovery liquid and performing solid-liquid separation 5, wherein lithium carbonate contained in a separated liquid 5 obtained by performing the solid-liquid separation 5 is used to produce the aqueous organic acid lithium solution.

The recovery liquid is obtained by recovering only lithium ions with a lithium ion separation device, and as described above, since it is an aqueous solution of lithium hydroxide with few impurities, by adding carbon dioxide thereto, an aqueous solution containing lithium carbonate can be obtained. By subjecting the aqueous solution containing lithium carbonate to the solid-liquid separation 5, high-purity lithium carbonate with few impurities can be obtained. In addition, the separated liquid 5 obtained by the solid-liquid separation 5 becomes a saturated aqueous solution of lithium carbonate in which lithium carbonate is dissolved, and thus it can be used as lithium carbonate in producing an aqueous lithium acetate solution. By using the separated liquid 5 as a lithium carbonate source, it is possible to cope with various operating conditions.

A method for producing a lithium compound according to a ninth form of the present embodiment is a production method where, in the above eighth form,
the carbon dioxide is generated by producing the aqueous organic acid lithium solution.

In the production of the aqueous organic acid lithium solution, carbon dioxide is produced together with the organic acid lithium due to the reaction between the organic acid such as acetic acid and lithium carbonate. By using the carbon dioxide as the carbon dioxide to be added to the recovery liquid, which is an aqueous solution of lithium hydroxide containing few impurities, in which only lithium ions are recovered in the lithium ion separation device, the waste amount of carbon dioxide can be reduced.

A method for producing a lithium compound according to a tenth form of the present embodiment is a production method where, in the above first to ninth forms,
lithium hydroxide is obtained by performing the solid-liquid separation 1.

For the solid-liquid separation 1, a crystallized aqueous lithium hydroxide solution obtained by producing the aqueous lithium hydroxide solution, preferably a crystallized recovery liquid recovered using the lithium ion separation device of the fourth form is provided. Therefore, a separated solid 1-1 obtained by the solid-liquid separation 1 becomes lithium hydroxide with high purity. That is, it can be said that the tenth form is a form in which the lithium compound produced by the method for producing a lithium compound of the present embodiment is lithium hydroxide.

A method for producing a lithium compound according to an eleventh form of the present embodiment is a production method where, in the above eighth to tenth forms, lithium carbonate is obtained by performing the solid-liquid separation 5.

In performing the solid-liquid separation 5, as described above, an aqueous solution containing lithium carbonate is provided by recovering only lithium ions with the lithium ion separation device and adding carbon dioxide to the recovery liquid, which is an aqueous lithium hydroxide solution with few impurities. Therefore, a separated solid 5 obtained by the solid-liquid separation 5 becomes lithium carbonate with high purity. That is, it can be said that the eleventh form is a form in which the lithium compound produced by the method for producing a lithium compound of the present embodiment is lithium carbonate.

A method for producing a lithium compound according to a twelfth form of the present embodiment is a production method where, in the above first to eleventh forms, a metal forming the metal hydroxide and a metal forming the organic acid metal are the same.

The metal hydroxide is used by producing the above aqueous lithium hydroxide solution, and the organic acid metal is by-produced by producing the above aqueous lithium hydroxide solution, and is supplied to an electrochemical device to regenerate an organic acid such as acetic acid, and the metal is regenerated as a metal hydroxide. Then, the recovered metal hydroxide is used by producing an aqueous lithium hydroxide solution. That is, the twelfth form is a form that means that the metal is circulated, and by doing so, it is possible to reduce the amount of waste.

A method for producing a lithium compound according to a thirteenth form of the present embodiment is a production method where, in the above first to twelfth forms,
the metal is at least one selected from sodium, potassium and barium.

When the metal is one of the above, the reaction in producing the aqueous lithium hydroxide solution proceeds more rapidly, and it is easier to regenerate with an electrochemical device. Therefore, lithium hydroxide can be produced efficiently.

An apparatus for producing a lithium compound according to a fourteenth form of the present embodiment is a lithium compound production apparatus including
a reaction tank 1, a reaction tank 2, an electrochemical device, and a return pipe,
wherein the reaction tank 1 is a tank for mixing lithium carbonate, an acid containing an organic acid, and water to produce an aqueous organic acid lithium solution,
the reaction tank 2 is a tank for mixing the aqueous organic acid lithium solution and a metal hydroxide to produce an aqueous lithium hydroxide solution,
the electrochemical device is a device for regenerating an organic acid used in producing the aqueous organic acid lithium solution from an aqueous solution obtained by removing lithium hydroxide from the aqueous lithium hydroxide solution, and
the return pipe is a pipe for returning the regenerated organic acid to the reaction tank 1.

The apparatus for producing a lithium compound of the present embodiment can produce an aqueous organic acid lithium solution (reaction tank 1), an aqueous lithium hydroxide solution (reaction tank 2), and regenerate an organic acid such as acetic acid from an organic acid metal (electrochemical device) that is by-produced by producing an aqueous lithium hydroxide solution, and return the regenerated organic acid to the reaction tank 1 via a return pipe for use. Therefore, the production apparatus is suitably used in the method for producing a lithium compound of the present embodiment. That is, according to the apparatus for producing a lithium compound of the present embodiment, it is possible to efficiently produce a high-purity lithium compound from low-grade lithium carbonate containing impurities such as salt water.

An apparatus for producing a lithium compound according to a fifteenth form of the present embodiment is a production apparatus further including, in the above fourteenth form,
a lithium ion separation device equipped with a Li permselective membrane that recovers only lithium ions from the aqueous lithium hydroxide solution into a recovery liquid.

An apparatus for producing a lithium compound according to a sixteenth form of the present embodiment is a production apparatus further including, in the above fifteenth form,
a crystallization device that crystallizes the recovery liquid.

Equipped with a crystallization device, it becomes easier to obtain lithium hydroxide with higher purity.

As mentioned above, by providing a lithium ion separation device, high-purity lithium hydroxide can be obtained without the need to use chemicals, and high-purity lithium hydroxide can be easily obtained simply by crystallizing the recovery liquid.

### [Method for Producing Lithium Compound]

The method for producing a lithium compound of the present embodiment will be described in further detail below.

The method for producing a lithium compound of the present embodiment is a production method including
mixing lithium carbonate, an acid containing an organic acid, and water in a reaction tank 1 to produce an aqueous organic acid lithium solution containing an organic acid lithium,
mixing the aqueous organic acid lithium solution and a metal hydroxide in a reaction tank 2 to produce an aqueous lithium hydroxide solution, and
returning an organic acid, which is regenerated by using an electrochemical device from an organic acid metal by-produced by producing the aqueous lithium hydroxide solution, to the reaction tank 1 and using the regenerated organic acid as the organic acid.

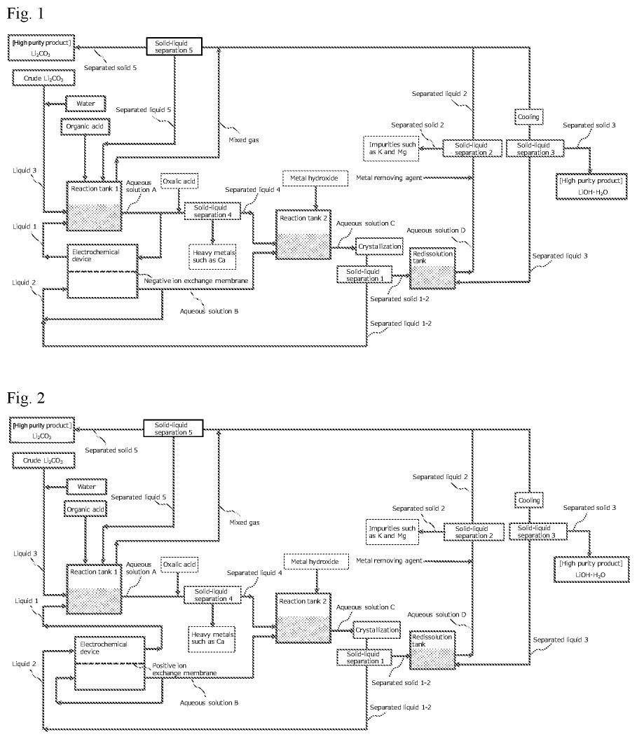

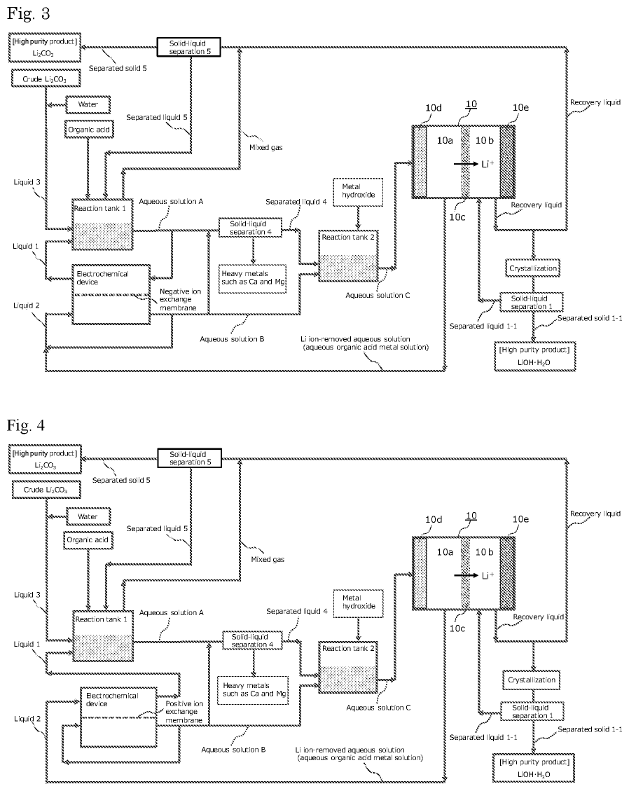

The method for producing a lithium compound according to the present embodiment will be described with reference to FIGS. 1 to 4. FIGS. 1 to 4 are flowcharts showing a preferred embodiment of a lithium hydroxide production apparatus capable of carrying out a lithium compound production method of the present embodiment. FIGS. 1 and 2 show flowcharts in which method 2 is employed as a method for obtaining high-purity lithium hydroxide from an aqueous lithium hydroxide solution. FIG. 1 shows a flowchart in which the ion exchange membrane used in the electrochemical device is a negative ion exchange membrane (anion exchange membrane), and FIG. 2 shows a flowchart in which the ion exchange membrane is a positive ion exchange membrane (cation exchange membrane). FIG. 3 is a flowchart in which method 1 is adopted and the ion exchange membrane used in the electrochemical device is a negative ion exchange membrane (anion exchange membrane), and FIG. 4 shows a flowchart in which method 1 is adopted and the ion exchange membrane used in the electrochemical device is a positive ion exchange membrane (cation exchange membrane).

The flowcharts shown in FIGS. 1 and 2 show that a liquid 1 (an organic acid such as acetic acid), a raw material crude lithium carbonate (low-grade lithium carbonate), and a liquid 3 (lithium carbonate liquid) containing a separated liquid 5 obtained by solid-liquid separation 5 react in the reaction tank 1 to produce an aqueous solution A (aqueous organic acid lithium solution), which then reacts with an aqueous solution B (aqueous solution containing metal hydroxide) in the reaction tank 2 to produce an aqueous solution C (aqueous lithium hydroxide solution). Thus, in the reaction tank 1, lithium carbonate and an organic acid such as acetic acid are reacted to produce an aqueous organic acid lithium solution containing organic acid lithium, and in the reaction tank 2, the organic acid lithium is reacted with a metal hydroxide to produce an aqueous lithium hydroxide solution.

Further, when method 1 is adopted as a method for obtaining high-purity lithium hydroxide from the aqueous lithium hydroxide solution, the aqueous solution C produced in the reaction tank 2 is supplied as a raw liquid to a lithium ion separation device 10 equipped with a Li permselective membrane 10c, and only lithium ions are recovered to form a Li ion-removed aqueous solution, which is supplied to an electrochemical device as an organic acid metal aqueous solution. Further, when method 2 is employed, the aqueous solution C undergoes crystallization and the solid-liquid separation 1 to obtain lithium hydroxide as a separated solid 1-2 and to obtain a separated liquid 1-2, which is an aqueous solution containing metal acetate, and the separated liquid 1-2 is supplied to an electrochemical device as an organic acid metal aqueous solution.

In the electrochemical device having a negative ion exchange membrane (anion exchange membrane) in FIG. 1, the organic acid metal aqueous solution (separated liquid 1-2) is supplied as a catholyte, and the aqueous solution A (organic acid lithium aqueous solution) is supplied as an anolyte. Acetate ions are regenerated from the organic acid metal contained in the organic acid metal aqueous solution to form the aqueous solution B (aqueous solution containing metal hydroxide).

On the other hand, the aqueous solution A supplied to the electrochemical device becomes the liquid 1 (an acid containing an organic acid such as acetic acid) further containing organic acid ions regenerated from the organic acid metal aqueous solution, and is used for the reaction with lithium carbonate in the reaction tank 1 as described above. In this way, in the electrochemical device, an organic acid such as acetic acid is regenerated from an organic acid metal by-produced by producing an aqueous lithium hydroxide solution.

When using an electrochemical device having a positive ion exchange membrane (cation exchange membrane) in FIG. 2, the organic acid metal aqueous solution (separated liquid 1-2) is supplied as an anolyte, and metal ions are regenerated from the organic acid metal contained in the organic acid metal aqueous solution to form the liquid 1 containing an organic acid. A portion of the aqueous solution B obtained by recovering metal ions from the organic acid metal aqueous solution in the electrochemical device is circulated and supplied to a cathode tank, the uncirculated aqueous solution B is supplied to the reaction tank 2, and the liquid 1 is used for the reaction with lithium carbonate in the reaction tank 1. In this way, even if any type of ion exchange membrane, such as a negative ion exchange membrane (anion exchange membrane) and a positive ion exchange membrane (cation exchange membrane), is used as the ion exchange membrane used in the electrochemical device, an organic acid such as acetic acid is regenerated from the organic acid metal by-produced by producing the aqueous lithium hydroxide solution.

In addition, in the lithium ion separation device 10 of FIGS. 3 and 4, the recovery liquid obtained by recovering only the lithium ions from the aqueous lithium hydroxide solution becomes high-purity lithium hydroxide through crystallization and the solid-liquid separation 1, or becomes high-purity lithium carbonate through a reaction with a mixed gas containing carbon dioxide that is by-produced in the reaction of mixing lithium carbonate with an organic acid such as acetic acid in the reaction tank 1.

Also, the Li ion-removed aqueous solution obtained by recovering only lithium ions from the aqueous lithium hydroxide solution is supplied to the electrochemical device as an organic acid metal aqueous solution containing the organic acid metal produced in the reaction tank 2. As already mentioned, it is supplied to the electrochemical device as a catholyte or as an anolyte, depending on the type of ion exchange membrane that the electrochemical device has. In addition, the separated liquid 1-1 after lithium hydroxide is removed from the recovery liquid through crystallization and the solid-liquid separation 1 is an aqueous solution containing a very small amount of lithium hydroxide, and as shown in FIGS. 3 and 4, it may be supplied to a recovery liquid tank 10b of the lithium ion separation device 10.

### (Producing an Aqueous Organic Acid Lithium Solution)

The production method of the present embodiment includes mixing lithium carbonate, an acid containing an organic acid, and water in the reaction tank 1 to produce an aqueous organic acid lithium solution containing organic acid lithium.

Since lithium carbonate is usually supplied in the form of a slurry, and an acid containing an organic acid such as acetic acid is supplied as an aqueous solution, an aqueous organic acid lithium solution containing organic acid lithium, such as lithium acetate, produced by the reaction of lithium carbonate and an acid containing an organic acid such as acetic acid in an aqueous solution can be obtained. For example, when acetic acid is used as the organic acid, the reaction between lithium carbonate and an acid containing acetic acid is represented by the following chemical reaction formula (1). A lithium acetate battery material chamber produced by the following reaction dissolves in water in a reaction tank and exists in a state in which acetate ions and lithium ions are separated, forming an aqueous solution containing lithium ions.

Li₂CO₃+2CH₃COOH→2CH:COOLi+CO₂+H₂O (1)

In addition to acetic acid, preferable examples of organic acids that can be used in the production method of the present embodiment include a monovalent carboxylic acid having one carboxy group represented by a general formula R¹—COOH (R¹ is a hydrogen atom or an aliphatic hydrocarbon group), such as formic acid, propionic acid, and butanoic acid: a divalent carboxylic acid having two carboxy groups represented by a general formula R²—(COOH)₂ (R² is a single bond or an aliphatic hydrocarbon group), such as oxalic acid, malonic acid, itaconic acid, malic acid, and adipic acid; and a trivalent carboxylic acid having three carboxy groups represented by R³—(COOH)₃ (R³ is a single bond or an aliphatic hydrocarbon group), such as aconitic acid and citric acid.

The aliphatic hydrocarbon group of R¹ in the general formula of the monovalent carboxylic acid is preferably an alkyl group or an alkenyl group, more preferably an alkyl group, in consideration of reactivity in mixing with lithium carbonate, availability, cost, and the like. A hydrogen atom is also preferable from the same point of view.

The aliphatic hydrocarbon group of R¹ may be either linear or branched, and linear is preferred in consideration of reactivity in mixing with lithium carbonate, availability, cost, and the like. From the same viewpoint, the number of carbon atoms in the aliphatic hydrocarbon group is preferably 1 or more, and the upper limit is preferably 8 or less, more preferably 4 or less, still more preferably 3 or less, and even more preferably 2 or less.

In addition, the aliphatic hydrocarbon group of R¹ may be substituted with a halogen atom such as a fluorine atom and a chlorine atom, a hydroxy group, or the like.

The aliphatic hydrocarbon group of R² in the general formula of the divalent carboxylic acid is preferably an alkylene (alkanediyl) group or an alkenylene (alkenediyl) group, more preferably an alkylene (alkanediyl) group, in consideration of reactivity in mixing with lithium carbonate, availability, cost, and the like. A single bond is also preferable from the same point of view:

The aliphatic hydrocarbon group of R² may be either linear or branched, and linear is preferred in consideration of reactivity in mixing with lithium carbonate, availability, cost, and the like. From the same viewpoint, the number of carbon atoms in the aliphatic hydrocarbon group is preferably 1 or more, and the upper limit is preferably 8 or less, more preferably 4 or less, still more preferably 3 or less, and even more preferably 2 or less.

In addition, the aliphatic hydrocarbon group of R² may be substituted with a halogen atom such as a fluorine atom and a chlorine atom, a hydroxy group, or the like.

The aliphatic hydrocarbon group of R³ in the general formula of the trivalent carboxylic acid is preferably an alkanetriyl group or an alkenetriyl group, more preferably an alkanetriyl group, in consideration of reactivity in mixing with lithium carbonate, availability, cost, and the like.

The aliphatic hydrocarbon group of R³ may be either linear or branched, and linear is preferred in consideration of reactivity in mixing with lithium carbonate, availability, cost, and the like. From the same viewpoint, the number of carbon atoms in the aliphatic hydrocarbon group is preferably 1 or more, and the upper limit is preferably 8 or less, more preferably 4 or less, and still more preferably 3 or less.

In addition, the aliphatic hydrocarbon group of R³ may be substituted with a halogen atom such as a fluorine atom and a chlorine atom, a hydroxy group, or the like, and is preferably substituted with a hydroxy group.

As an organic acid that can be used in the production method of the present embodiment, of the aforementioned organic acids, formic acid and acetic acid are preferable and acetic acid is particularly preferable as the monovalent carboxylic acid. As the divalent carboxylic acid, oxalic acid is preferable, and as the trivalent carboxylic acid, citric acid is preferable.

Lithium carbonate is highly reactive with an acid containing an organic acid such as acetic acid, and thus the reaction progresses rapidly. Therefore, heating is not required; however, heating may be performed as needed, and in that case, the temperature is room temperature (23° C.) to 120° C., preferably room temperature (23° C.) to 80° C.

In addition, as shown in the above chemical reaction formula (1), the amount of organic acid such as acetic acid used may be twice the molar ratio of lithium carbonate, or may be supplied in excess, for example, about 2 to 5 times. Since the yield of lithium acetate improves by supplying excessively, lithium hydroxide can be produced more efficiently.

The lithium carbonate used by producing the aqueous organic acid lithium solution is a starting material in the production method of the present embodiment, that is, a raw material for producing lithium hydroxide.

Examples of lithium carbonate include, in addition to salt water such as salt lake brine and geothermal brine, seawater, mining wastewater, and low-grade lithium carbonate obtained from lithium-containing processed water extracted from a processed member of a lithium secondary battery: In that manner, the lithium carbonate used in the production method of the present embodiment does not need to be special grade reagent.

The low-grade lithium carbonate obtained from the salt water or the like, which can be used in the production method of the present embodiment, contains moisture due to moisture absorption, salt water, or the like, and various other impurities. For example, low-grade lithium carbonate usually contains lithium, boron, sodium, potassium, magnesium, calcium, etc., and the content thereof as metal atoms is usually 5,000 to 300,000 mass ppm, 10 to 200 mass ppm, 300 to 2,000 mass ppm, 100 to 800 mass ppm, 200 to 1,500 mass ppm, and 1,500 to 4,500 mass ppm. Low-grade lithium carbonate may contain chlorine in addition to the above, in which case the content is usually 300 to 2,000 mass ppm, and may contain aluminum, zinc, lead, etc., in which case, the content thereof as metal atoms is usually 0.5 to 50 mass ppm, 0.1 to 10 mass ppm, and 0.1 to 20 mass ppm. In addition, it may contain sulfate, usually in a content of 50 to 1,000 mass ppm as SO₄. Since the low-grade lithium carbonate used in the production method of the present embodiment changes depending on the properties of the salt water, it goes without saying that what the low-grade lithium carbonate can contain is not limited to the above.

The acid containing an organic acid such as acetic acid may contain an organic acid such as acetic acid described above, and the reaction represented by the chemical reaction formula (1) may proceed, and the total amount thereof may be an organic acid such as acetic acid, or may contain an acid other than an organic acid such as acetic acid. From the viewpoint of obtaining lithium hydroxide more efficiently, it is preferable that the total amount is an organic acid such as acetic acid. In this case, the organic acids described above may be used alone or in combination of two or more.

In addition, an inorganic acid such as hydrochloric acid and sulfuric acid can also be used as an acid other than an organic acid such as acetic acid. Moreover, a plurality of organic acids may be used.

In the production method of the present embodiment, a method of supplying lithium carbonate, water, and organic acid to the reaction tank 1 is not particularly limited as long as they can be mixed in the reaction tank 1 as a result. Examples thereof include a method in which water is added to low-grade lithium carbonate and supplied to the reaction tank 1 as a slurry, an organic acid is directly supplied to the reaction tank 1, or an organic acid and water are mixed and added to low-grade lithium carbonate to form a slurry and supplied to the reaction tank 1.

### (Producing Aqueous Lithium Hydroxide Solution)

The production method of the present embodiment includes reacting an organic acid lithium such as lithium acetate with a metal hydroxide to produce an aqueous lithium hydroxide solution.

For example, when acetic acid is used as the organic acid and the organic acid lithium becomes lithium acetate, the reaction between lithium acetate and a metal hydroxide is represented by the following chemical reaction formula (2).

CH₃COOLi+MeOH+H₂O→CH₃COOMe+LiOH·H₂O (2)

In the formula, Me represents a metal.

As mentioned above, similar to lithium carbonate and the acid containing an organic acid such as acetic acid, organic acid lithium such as lithium acetate and a metal hydroxide are highly reactive, and thus the reaction progresses quickly. Therefore, heating is not required; however, heating may be performed as needed, and in that case, the temperature is room temperature (23° C.) to 120° C., and preferably room temperature (23° C.) to 80° C. For convenience, the room temperature is indicated as 23° C.; however, it is only for convenience, and the above temperature condition does not mean that the temperature is 23° C. or higher, but means that the temperature is equal to or higher than the room temperature (environmental temperature) in the case of heating.

Preferable examples of the metal hydroxide include sodium hydroxide, potassium hydroxide, and barium hydroxide, with sodium hydroxide and potassium hydroxide being more preferred, and potassium hydroxide being even more preferred. By using such a metal hydroxide, the reaction represented by the chemical reaction formula (2) proceeds easily, and lithium hydroxide can be obtained efficiently. These metal hydroxides may be used alone or in combination of two or more; however, from the viewpoint of simplifying the production method and improving efficiency, it is preferable to use a metal hydroxide alone, that is, to use one kind of metal hydroxide.

### (Electrochemical Device)

In the production method of the present embodiment, the organic acid such as acetic acid used in producing the aqueous organic acid lithium solution containing the organic acid lithium such as lithium acetate is regenerated from “CH₃COOMe” in the chemical reaction formula (2), that is, the organic acid metal such as metal acetate that is by-produced by producing the aqueous lithium hydroxide solution, using an electrochemical device.

The electrochemical device is not particularly limited as long as it can perform electrolyzation. For example, a diaphragm electrochemical device equipped with an ion exchange membrane capable of recovering an organic acid such as acetic acid from an organic acid metal such as metal acetate is preferably employed. As the ion exchange membrane, a positive ion exchange membrane (cation exchange membrane) and a negative ion exchange membrane (anion exchange membrane) are employed. A bipolar membrane type electrochemical device can also be used, and in this case, a negative ion exchange membrane (anion exchange membrane) and a positive ion exchange membrane (cation exchange membrane) and a bipolar type ion exchange membrane (membrane consisting of an anion exchange layer and a cation exchange layer) are used. Of these, as the ion exchange membrane, a positive ion exchange membrane (cation exchange membrane) is preferable.

Any anion exchange membrane can be used without any particular limitation as long as it can recover organic acid ions such as acetate ions. Preferred examples thereof include a strongly basic anion exchange resin and a weakly basic anion exchange resin having an amino group as a functional group, and an anion exchange membrane using a strongly basic anion exchange resin having a quaternary ammonium group.

The cation exchange membrane can be used without any particular limitation as long as it can recover sodium ions, etc. Preferred examples thereof include a strongly acidic cation exchange membrane in which a sulfone group is introduced into a fluororesin matrix, Nafion 115, Nafion 212, and Nafion 350 (manufactured by Chemrous), a strongly acidic cation exchange membrane in which a sulfone group is introduced into a styrene-divinylbenzene copolymer matrix, Neosepta CSE (manufactured by Astom), and selemion, which is a hydrocarbon-based cation exchange membrane (manufactured by AGC Engineering Co., Ltd.).

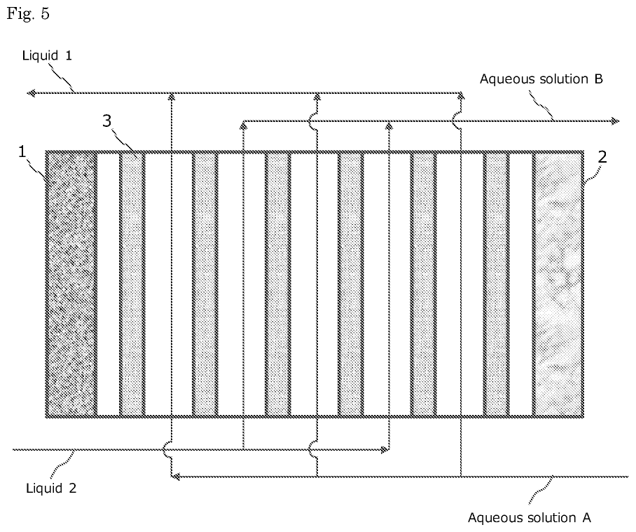

As the electrochemical device, for example, a device as shown in FIG. 5 is preferably used. The electrochemical device shown in FIG. 5 includes an anode 1, a cathode 2, and a plurality of anion exchange membranes 3. A liquid 2 supplied as a catholyte to a cathode side of the electrochemical device, an aqueous solution A supplied as an anolyte to an anode side, and a liquid 1 and an aqueous solution B discharged from the electrochemical device correspond to FIG. 1 in which the ion exchange membrane is an anion exchange membrane. Although not shown in the present description, when the ion exchange membrane included in the electrochemical device is a cation exchange membrane, it can be a plurality of cation exchange membranes as in the case of the anion exchange membranes.

The liquid 2 supplied as a catholyte and an anolyte is an aqueous solution containing an organic acid metal such as a metal acetate that is by-produced by producing the aqueous lithium hydroxide solution, and is preferably an aqueous solution containing an organic acid metal such as a metal acetate that is by-produced after recovering the lithium hydroxide from the aqueous solution obtained by producing the aqueous lithium hydroxide solution. The liquid 2 more specifically contains an organic acid metal aqueous solution as shown in FIGS. 1 to 4, and when method 1 is adopted as a method for obtaining high-purity lithium hydroxide from an aqueous lithium hydroxide solution, the organic acid metal aqueous solution contains a Li ion-removed aqueous solution containing an organic acid metal obtained by removing lithium hydroxide from the aqueous lithium hydroxide solution by recovering only lithium ions using a lithium ion separation device (see FIGS. 3 and 4). Further, when method 2 is adopted, a separated liquid 1-2 is obtained by crystallizing an aqueous lithium hydroxide solution and performing the solid-liquid separation 1. In the electrochemical device, organic acid ions such as acetate ions are recovered in the anolyte from organic acid metals such as metal acetate contained in the catholyte (see FIGS. 1 and 2).

As shown in FIGS. 1 and 3, when an anion exchange membrane is adopted as the ion exchange membrane of the electrochemical device, the liquid 2 that becomes the catholyte may contain the aqueous solution B together with the Li ion-removed aqueous solution obtained by the lithium ion separation device or the separated liquid 1-2 obtained by the solid-liquid separation 1. On the other hand, when a cation exchange membrane is adopted as the ion exchange membrane of the electrochemical device, as shown in FIGS. 2 and 4, the liquid 2 that becomes the anolyte is the Li ion-removed aqueous solution obtained by the lithium ion separation device, or the separated liquid 1-2 obtained by the solid-liquid separation 1.

As the anolyte, when the electrochemical devices of FIGS. 1 and 3 have an anion exchange membrane, it is preferable to circulate and use potassium hydroxide (aqueous solution A) and the aqueous organic acid lithium solution obtained by producing the above aqueous organic acid lithium solution. By using an aqueous solution with a high salt concentration, it is possible to reduce the electric power required for diaphragm electrolysis when, for example, a diaphragm-type electrochemical device is employed, and also to reduce waste.

When the electrochemical device has a cation exchange membrane and method 2 in FIG. 2 is adopted, the separated liquid 1-2 obtained by crystallizing an aqueous lithium hydroxide solution as the anolyte and performing the solid-liquid separation 1 is used. When the lithium ion separation device in FIG. 4 is adopted, a Li ion-removed aqueous solution (organic acid metal aqueous solution) is used.

The aqueous solution B discharged from the cathode side of the electrochemical device is a residual liquid after the organic acid ions have been recovered from the organic acid metal contained in the liquid 2 in the case of having the anion exchange membrane shown in FIG. 1 and a liquid in which metal ions are recovered from the organic acid metal contained in the liquid 2 in the case of having the cation exchange membrane shown in FIG. 2, and is an aqueous solution containing a metal hydroxide formed by a metal contained in the organic acid metal. Since the aqueous solution B is an aqueous solution containing a metal hydroxide in any case, it is preferably used for the reaction with the organic acid lithium in the reaction tank 2 from the viewpoint of reducing waste. The aqueous solution B in the case of using the lithium ion separation device of FIGS. 3 and 4 can also be changed according to the type of ion exchange membrane that the electrochemical device has, and in any case it will be an aqueous solution containing a metal hydroxide.

In the case of FIGS. 1 and 2, as described above, the metal contained in the metal hydroxide becomes the organic acid metal (aqueous solution C, separated liquid 1-2) through the reaction in the reaction tank 2 from the metal hydroxide (aqueous solution B) and becomes the metal hydroxide (aqueous solution B) from the organic acid metal (liquid 2) in the electrochemical device, so the metal is circulated. Further, in the case of using the lithium ion separation device in FIGS. 3 and 4, the metal contained in the metal hydroxide becomes the organic acid metal (aqueous solution C) as in the case of FIGS. 1 and 2 above. Then, discharged as the Li ion-removed aqueous solution (aqueous organic acid metal solution) from the lithium ion separation device, and the metal becomes a metal hydroxide (aqueous solution B) from the organic acid metal (liquid 2) in the electrochemical device, so the metal is circulated.

Therefore, the circulated metal is the same as the metal contained in the aforementioned metal hydroxide. The metal contained in the metal hydroxide is preferably sodium, potassium, barium, or the like, more preferably sodium or potassium, and still more preferably potassium. These metals may be used alone or in combination of two or more.

In the liquid 1 discharged from the electrochemical device, organic acid ions are recovered from the organic acid metal contained in the liquid 2 (FIG. 1), or metal ions contained in the liquid 2 are removed (FIG. 2), resulting in an aqueous solution containing a large amount of organic acids such as acetic acid. In the production method of the present embodiment, the liquid 1 is used as an organic acid such as acetic acid that reacts with lithium carbonate. The same applies to the case where the lithium ion separation device shown in FIGS. 3 and 4 is employed.

Also, when the above organic acid ions are recovered by an electrochemical device, for example, hydrogen is generated from the anode and oxygen is generated from the cathode.

The generated hydrogen and oxygen accompany the liquid 1 discharged from the electrochemical device, and are generated as a mixed gas together with carbon dioxide in producing the aqueous organic acid lithium solution. As described above, carbon dioxide can be added as a mixed gas to the separated liquid 2, which is an aqueous lithium hydroxide solution with reduced impurities, to obtain lithium carbonate (see also FIGS. 1 and 2). Moreover, when a lithium ion separation device is provided, as shown in FIG. 3, the mixed gas can be added to the recovery liquid discharged from the lithium ion separation device to obtain lithium carbonate.

(Lithium Ion Separation Device Equipped with Li Permselective Membrane)

In the production method of the present embodiment, it is preferable to recover only lithium ions to a recovery liquid from an aqueous lithium hydroxide solution obtained by producing the aqueous lithium hydroxide solution using a lithium ion separation device equipped with a Li permselective membrane. By using a lithium ion separation device, high-purity lithium hydroxide can be obtained without using chemicals, and high-purity lithium hydroxide can be easily obtained only by crystallizing the recovery liquid.

As shown in FIGS. 3 and 4, the lithium ion separation device 10 is a device that includes a raw liquid tank 10a that supplies an aqueous solution C (aqueous lithium hydroxide solution), the recovery liquid tank 10b that stores a recovery liquid, and the Li permselective membrane 10c that selectively permeates only lithium ions. In FIGS. 3 and 4, lithium ions contained in the aqueous solution C (aqueous lithium hydroxide solution) supplied to the raw liquid tank 10a pass through the Li permselective membrane 10c and are recovered in the recovery liquid. Also, it is shown that the lithium ion separation device 10 has a first electrode 10d (anode) in one tank (raw liquid tank 10a side) and a second electrode 10e (cathode) in the other tank (recovery liquid tank 10b side). In this way, the lithium ions move from the anode side to the cathode side, thereby moving from the aqueous solution C (aqueous lithium hydroxide solution) supplied to the raw liquid tank 10a to the recovery liquid in the recovery liquid tank 10b. Subsequently, for the lithium ions recovered to the recovery liquid, the lithium hydroxide produced in crystallization such as evaporation crystallization and cooling crystallization and a filtrate are separated by solid-liquid separation or the like, and the lithium hydroxide is further dried as necessary to obtain high-purity lithium hydroxide.

The lithium ion separation device 10 may have a storage tank (not shown) for storing the raw liquid and the recovery liquid in the raw liquid tank 10a and the recovery liquid tank 10b. By having the storage tank, it is possible to store the raw liquid and the recovery liquid as necessary, and to respectively circulate the raw liquid and the recovery liquid between the raw liquid tanks 10a and the storage tank and between the recovery liquid tank 10b and the storage tank. Therefore, it is possible to cope with various situations.

For example, in the case where a storage tank for the recovery liquid is provided, in the recovery liquid circulation and the lithium ion separation device 10, when the recovery liquid obtained by recovering lithium ions is temporarily stored in the storage tank and the concentration of lithium ions contained in the recovery liquid in the storage tank reaches a certain level or more, it is possible to crystallize the recovery liquid from the storage tank and perform solid-liquid separation or other processing as necessary to obtain lithium hydroxide as a product. In addition, it becomes easier to adjust the distribution of the recovery liquid according to the required amount of lithium hydroxide and lithium carbonate as products.

Moreover, for example, when a raw liquid storage tank is provided, depending on the circulation of the raw liquid and the operating conditions of the lithium ion separation device, the aqueous solution C from the reaction tank 2 can be temporarily stored and then supplied to the raw liquid tank 10a of the lithium ion separation device 10. Also, depending on the operating conditions of the electrochemical device, the Li ion-removed aqueous solution after the lithium ions have been recovered in the lithium ion separation device 10 can be temporarily stored in the storage tank and supplied to the electrochemical device.

As shown in FIGS. 3 and 4, the lithium ion separation device 10 used in the production method of the present embodiment may be in a form in which one tank is partitioned by the Li permselective membrane 10c into separate tanks of the raw liquid tank 10a and the recovery liquid tank 10b, or may be in a form in which the two tanks of the raw liquid tank 10a and the recovery liquid tank 10b are connected via the Li permselective membrane 10c.

The Li permselective membrane is a membrane that has a function of moving Li ions in the aqueous solution C (aqueous lithium hydroxide solution) that is the raw liquid to the recovery liquid, and is generally provided so as to partition the aqueous solution C (aqueous lithium hydroxide solution) that is the raw liquid and the recovery liquid (see FIGS. 3 and 4).

The Li permselective membrane preferably includes a Li permselective membrane body composed of a super Li ion conductor (ionic conductor) having an especially high ionic conductivity and a Li adsorption layer formed as a thin layer on a side to which the aqueous solution C (aqueous lithium hydroxide solution) that is the raw liquid is supplied.

When a super Li ion conductor is used for the Li permselective membrane body, Li recovery efficiency can be improved by increasing an ion current of Li ions flowing between electrodes. Here, Li ions contained in an aqueous solution are present as Li hydrated ions in which water molecules are coordinated around Li ions. Therefore, in order to further increase the ion current, it is effective to implement a situation in which water molecules are easily removed from a surface of the Li permselective membrane (interface between the Li permselective membrane and a raw liquid).

Therefore, a Li adsorption layer that adsorbs Li ions (excluding hydrates) in a Li ion extract is preferably formed on the surface of the Li permselective membrane. That is, the Li permselective membrane is preferably subjected to a surface Li adsorption treatment. As described later, the Li adsorption layer is preferably formed by modifying a surface of a material constituting the Li permselective membrane.

Preferred examples of a material constituting the Li permselective membrane body include an oxide and oxynitride containing Li as described below. That is, the Li permselective membrane preferably contains the following oxides, oxynitrides and the like containing Li.

Examples of the oxide containing Li include lithium lanthanum titanate: (Liₓ, La_{y})TiO_{z} (here, x=3a−2b, y=⅔−a, z=3−b, 0≤a≤⅙, 0≤b≤0.06, x>0) (hereinafter also referred to as “LLTO”), lithium lanthanum zirconate: Li₇La₃Zr₂O₁₂ (hereinafter also referred to as “LLZO”), lithium lanthanum niobate: Li₅La₃Nb₂O₁₂, and lithium lanthanum tantalate: Li₅La₃Ta₂O₁₂. More specifically, Li_{0.29}La_{0.57}TiO₃ (a≈0.1, b≈0) can be used as LLTO.

These materials can be obtained, for example, as a sintered body obtained by mixing particles formed of this material with a sintering aid or the like and sintering the mixture at a high temperature (1000° C. or higher). In this case, a surface of the Li permselective membrane can also be formed as a porous structure in which fine particles formed of LLTO are bonded (sintered), so that an effective area of a surface of the Li permselective membrane body can be increased. The same applies not only to LLTO but also to other oxides containing Li and oxynitrides containing Li described later.

Examples of the super Li ion conductor that can be used as the material constituting the Li permselective membrane body include, as the oxide containing Li, Li_{1+x+y}Alₓ(Ti,Ge)₂₋ₓSi_{y}P_{3-y}O₁₂ (here, 0≤x≤0.6, 0≤y≤0.6) (Li₂O—Al₂O₃—SiO₂—P₂O₅—TiO₂—GeO₂-based, hereinafter also referred to as “LASiPTiGeO”), which is a Li-substituted Na super ionic conductor (NASICON) crystal, in addition to the above LLTO, LLZO, and the like.

Preferable examples of the oxynitride containing Li include lithium oxynite phosphate (Li₃PON, hereinafter also referred to as “LiPON”), a nitride of LLTO (LLTON), a nitride of LLZO (LLZON), and a nitride of LASiPTiGeO (LASiPTiGeON).

The above super Li ion conductor such as an oxide and an oxynitride containing Li contains Li as one of constituent elements thereof, and Li ions outside the crystal migrate between Li sites in the crystal, thereby exhibiting ion conductivity. Although Li ions flow through the Li permselective membrane body, sodium ions cannot flow through the Li permselective membrane. At this time, Li ions (Lit) conduct in the crystal, and Li hydrate ions present in the raw liquid together with Li ions are not introduced to the Li sites, and thus do not conduct in the crystal. This point is the same as the Li permselective membrane described in WO 2015/020121.

Here, if only a large amount of lithium ions are particularly adsorbed on the surface of the Li permselective membrane body by the Li adsorption layer, water molecules of the lithium hydrated ions are removed during the adsorption, and since only lithium ions are present, conduction efficiency of lithium ions from a raw liquid side to a recovery liquid side in the Li permselective membrane body (ion current flowing through the Li permselective membrane body) can be increased.

The Li permselective membrane may not have an anode and a cathode as shown in FIG. 3, or an anode and a cathode may bond to the Li permselective membrane. When an anode and a cathode are provided, it is preferable that the anode is provided on the raw liquid side of the Li permselective membrane and the cathode is provided on the recovery liquid side thereof. With the structure, the solid-liquid interfaces of the raw liquid side of the Li permselective membrane and the recovery liquid side thereof are kept at an electropositive potential and an electronegative potential, respectively, and lithium ions can be recovered.

As the materials for the anode and the cathode, metal materials not causing electrochemical reaction in the raw liquid and the recovery liquid can be appropriately used, respectively. Examples of the metal materials usable here include SUS, Ti, Pt, Ni, Ti—Ir alloy, and alloys thereof.

The above material usable as the Li permselective membrane is solid and is known to exhibit electroconductivity by the Li ion flow running through crystals like free electrons. Consequently, in the case where the anode has an electropositive potential and the cathode has an electronegative potential, those of Li ions (positive ions) in the raw liquid on the anode side having reached the cathode side of the Li permselective membrane run toward the cathode side (recovery liquid) from the anode side (raw liquid) of the Li permselective membrane by ionic conduction. The Li ions having reached the cathode side of the Li permselective membrane are recovered in the recovery liquid. Consequently, after a predetermined period of time, the Li ion concentration in the raw liquid lowers and the Li ion concentration in the recovery liquid increases.

A Li adsorption layer is formed on the surface of the Li permselective membrane body as a thin film thereon, by chemical treatment of the Li permselective membrane body. Specifically, by acid treatment of one principal plane of the Li permselective membrane body (for example, LLTO), for example, by exposure of the plane to hydrochloric acid or nitric acid for 5 days, the layer is formed. It is presumed that, by the treatment, a substance layer (HLTO) having a composition of nearly H_{0.29}La_{0.57}TiO₃ can be formed, in which Li that is especially easily oxidizable among the constituent elements in the Li permselective membrane body (for example, LLTO), is substituted with hydrogen in an acid. Here, the formation of the thin layer (HLTO) on the surface is supported by the presence of a substance having a peak differing from that of the Li permselective membrane body (for example LLTO) from the results of X-ray diffractometry in WO2017/131051.

The H site in HLTO is a site that is naturally an Li site, and therefore H can be especially readily substitutable with a Li ion but can be hardly substituted with any other ion (for example, a sodium ion). Consequently, HLTO functions as a Li adsorption layer. In addition, HLTO is formed by reaction with an acid, and is therefore formed only on the outermost surface of the Li permselective membrane body.

Moreover, the lithium ion separation device may include a heating device for heating the recovery liquid. By heating the recovery liquid, the solubility of lithium ions in the recovery liquid is increased, and lithium ions are supplied from the aqueous lithium hydroxide solution, which is a raw liquid, by the increased amount, so that a large amount of lithium ions can be recovered.

### (Operating Conditions of Lithium Ion Separation Device)

In the case of heating the recovery liquid, the heating temperature is preferably 50° C. or higher, more preferably 60° C. or higher, still more preferably 70° C. or higher, and particularly preferably 80° C. or higher, and the upper limit is preferably 100° C. or lower, more preferably 95° C. or lower, and still more preferably 90° C. or lower. When the heating temperature is within the above range, lithium ions can be recovered more efficiently.

The type of the heating device is not particularly limited, and for example, a heat exchanger such as a jacket-type and a heater-type to run with electricity, a heat medium or the like can be used. Also, part of the recovery liquid can be heated by circulating it while passing it through a heating device. In this case, a shell/tube type heat exchanger can be used.

In the production method of the present embodiment, the aqueous solution C (aqueous lithium hydroxide solution), which is a raw liquid, can be under pH control. By pH control, lithium ion can be recovered efficiently. In that case, the pH is controlled preferably within a range of 12 or more and 14 or less. The pH range of 12 or more and 14 or less is a control target, and regarding the pH range of 12 or more and 14 or less of the raw liquid in the present embodiment, pH 12 can cover a value of 11.5 or more and less than 12.5, and pH 14 can cover a value of 13.5 or more and less than 14.5, that is, in fact, the pH range means a range of 11.5 or more and less than 14.5.

In addition, like the recovery liquid, the aqueous solution C (aqueous lithium hydroxide solution), which is a raw liquid, may also undergo temperature control, concretely, can be heated. In this way, the temperature of the recovery liquid can be readily controlled at 50° C. or higher, and lithium ions can be thereby recovered with high efficiency. In the case of raw liquid temperature control, the controlled temperature may fall within the range of temperature control for the recovery liquid mentioned above.

### (Crystallization and Solid-Liquid Separation 1)

In the production method of the present embodiment, when the lithium ion separation device of the method 1 is used, it is preferable to crystallize the recovery liquid obtained by recovering only lithium ions from the aqueous lithium hydroxide solution in the lithium ion separation device. By crystallization, lithium hydroxide can be purified and the purity can be improved.

In this case, that is, in the case of adopting method 1 in which only lithium ions are recovered using a lithium ion separation device equipped with a Li permselective membrane when obtaining high-purity lithium hydroxide from an aqueous lithium hydroxide solution, the method for crystallization is not particularly limited as long as lithium hydroxide can be obtained from the recovery liquid. Preferred examples include a method by filtration, cooling crystallization, evaporative crystallization, and pH crystallization, and evaporative crystallization is more preferred from the viewpoint of obtaining high-purity lithium hydroxide more efficiently.

In the lithium ion separation device, when the aqueous solution C (aqueous lithium hydroxide solution), which is a recovery liquid and a raw liquid, is heated, the energy required for evaporation can be reduced, and thus evaporative crystallization is preferably adopted.

In the case of evaporative crystallization, any ordinary evaporative crystallization method is employable with no specific limitation as the concrete method, and for example, the temperature is preferably controlled to be 80° C. or higher and 100° C. or lower. From the viewpoint of more efficiently performing evaporative crystallization, more preferably, the temperature is controlled to be 85° C. or higher, even more preferably 90° C. or higher.

From the viewpoint of more efficiently performing evaporative crystallization, preferably, the evaporative crystallization is performed in a reduced-pressure atmosphere. Under reduced pressure, the water vapor generated in the system can be discharged out, and for reuse, it can be added to the recovery liquid or the like.

For depressurization, the pressure is not specifically limited. In general, the pressure can be about 0.05 to 10 kPa as a vacuum pressure, and from the viewpoint of more efficiently performing evaporative crystallization, the pressure is preferably 0.1 to 5 kPa, more preferably 0.2 to 1 kPa.

Also, the evaporative crystallization can be performed with supply of an inert gas, and a nitrogen gas, an argon gas, or the like may be used as the inert gas in this case. From the viewpoint of suppressing carbonation, employable here is an oxygen-containing gas having a concentration of carbon monoxide, carbon dioxide or carbon hydride of 10 ppm or less. For obtaining lithium hydroxide having a higher purity, the concentration is preferably 1 ppm or less, more preferably 0.1 ppm or less.

Lithium hydroxide is obtained as a separated solid 1-1 by performing solid-liquid separation 1 on the liquid obtained by the above crystallization in which lithium hydroxide crystallizes. The separated solid 1-1 is preferably washed with ethanol or the like to remove impurities.

The solid-liquid separation 1 may be performed using a commonly used solid-liquid separation device, and a vacuum filter, a pressure filter, a centrifuge, a belt press, a screw press, or the like can be used as the solid-liquid separation device. The same applies to solid-liquid separation 2 to solid-liquid separation 5, which will be described later.

Next, purified lithium hydroxide is obtained by removing the ethanol, preferably by, for example, drying at room temperature. The lithium hydroxide of the separated solid 1-1 has a high purity and can be handled as a product produced by the production method of the present embodiment. In this case (when method 1 is employed), the recovery liquid obtained in the lithium ion separation device recovers only lithium ions, so that there are very few impurities, and the treatment such as redissolution in a redissolution tank and purification using a metal removing agent, which is preferably employed in method 2, is unnecessary.

In addition, in the solid-liquid separation 1, the separated liquid 1-1, which is a liquid after separating the lithium hydroxide from the separated solid 1-1, is an aqueous solution containing a small amount of lithium hydroxide that could not be separated by crystallization. The separated liquid 1-1 may be supplied to the recovery liquid tank of the lithium ion separation device as shown in FIGS. 3 and 4.

In addition, in the production method of the present embodiment, when the method 2 is adopted, the aqueous lithium hydroxide solution obtained by producing the aqueous lithium hydroxide solution may be crystallized. By crystallization, lithium hydroxide can be purified and the purity can be improved.

In this case, that is, when obtaining high-purity lithium hydroxide from an aqueous lithium hydroxide solution, when the method 2 is adopted to obtain an aqueous lithium hydroxide solution through crystallization, solid-liquid separation, redissolution, and impurity removal without using a lithium ion separation device, examples of a method of crystallization include a method by filtration, a method by heat concentration, and a method by pH crystallization, and a method by pH crystallization is preferable from the viewpoint of efficiency and suppressing energy consumption.

pH crystallization can be performed, for example, by adding an aqueous solution containing a metal hydroxide dropwise into an aqueous organic acid lithium solution. Specifically, in an aqueous solution containing a metal hydroxide obtained from an electrochemical device (for example, an aqueous solution B such as an aqueous potassium hydroxide solution), an aqueous solution A (aqueous organic acid lithium solution), or when performing solid-liquid separation 4, a separated liquid 4 is added dropwise thereto such that the molar ratio of potassium to lithium is preferably 0.5 times or more, more preferably 0.75 times or more, and still more preferably equimolar (1.0 times) or more, and the upper limit is preferably 4.0 times or less, more preferably 3.5 times or less, and still more preferably 3.0 times or less, to crystallize a lithium hydroxide hydrate. In this case, the time for dripping the aqueous organic acid lithium solution and the aqueous potassium hydroxide solution is preferably 1 to 6 hours.

Next, the liquid in which the lithium hydroxide hydrate is crystallized by the dropwise addition is preferably stirred for 15 minutes to 2 hours to age the lithium hydroxide crystals.

In FIGS. 1 and 2, the crystallization device is shown as an independent device; however, in the case of the method 2, it is preferable that the reaction tank 2 also serves as a crystallization device from the viewpoint of efficiency. As described above, crystallization can be performed by adding the aqueous solution A serving as seed crystals or the separated liquid 4 dropwise into the aqueous solution B serving as a mother liquor. Therefore, when the reaction tank 2 is provided with a unit for dripping the aqueous solution A or the separated liquid 4, crystallization can be performed simultaneously with the reaction between the organic acid lithium and the metal hydroxide, and as a result, there is no need to provide a separate crystallization device.

The separated solid 1-2 obtained by performing the solid-liquid separation 1 on the liquid in which lithium hydroxide is crystallized and which is obtained by aging lithium hydroxide crystals, is preferably washed with ethanol or the like to remove impurities.

In the case of the method 2, the solid-liquid separation 1 may be carried out using a commonly used solid-liquid separation device in the same manner as the solid-liquid separation 1 in the method 1, and as a solid-liquid separation device, a vacuum filter, a pressure filter, a centrifugal separator, a belt press, a screw press, etc. can be used.

Next, the purified lithium hydroxide is obtained by removing the ethanol, preferably by drying at room temperature, for example. The lithium hydroxide of the separated solid 1-2 has high purity and can be treated as a product produced by the production method of the present embodiment. In addition, since the purity of lithium hydroxide is improved by undergoing a treatment such as redissolution, which will be described later, it is of course possible to handle a substance that has undergone the treatment as a product.

In addition, the separated liquid 1-2 obtained by the solid-liquid separation 1 is an aqueous solution containing an organic acid metal, as described above, and is supplied to an electrochemical device, where organic acid ions are recovered from the organic acid metal, and used as an aqueous solution containing a metal hydroxide (aqueous solution B) for reaction with an organic acid lithium to obtain lithium hydroxide.

### (Re-Dissolution and Solid-Liquid Separation 2)

In the production method of the present embodiment, when the method 2 is employed to obtain high-purity lithium hydroxide from an aqueous lithium hydroxide solution, it is preferable to include producing an aqueous lithium hydroxide solution using the lithium hydroxide (separated solid 1-2) obtained by the above crystallization and the solid-liquid separation 1, and adding a metal removing agent that removes metals forming organic acid metals in the aqueous solution and performing the solid-liquid separation 2. Producing an aqueous lithium hydroxide solution using lithium hydroxide, which is the separated solid 1-2, is also referred to as “re-dissolving” because lithium hydroxide is converted back into an aqueous lithium hydroxide solution.

By redissolving, and adding a metal removing agent and performing the solid-liquid separation 2, impurities such as metals that form organic acid metals that may be contained in the lithium hydroxide purified by the above crystallization are removed, and lithium hydroxide with higher purity is obtained.

For the redissolution, pure water can be supplied as necessary to dissolve the lithium hydroxide, or the separated liquid 3 obtained by the solid-liquid separation 3 described later can also be used. An aqueous solution D obtained by redissolution is an aqueous solution containing lithium hydroxide of high purity.

Redissolution may be performed at room temperature, or may be performed by heating as necessary. By heating, the material can be redissolved more quickly, so that efficiency can be improved in terms of time. However, it leads to loss of thermal energy, and thus energy efficiency decreases. Therefore, the necessity of heating may be determined according to requests.

In the case of heating, the heating temperature is not particularly limited, and may vary depending on the properties of the low-grade lithium carbonate used as the starting material, the scale of an apparatus, etc., and cannot be unconditionally determined. However, considering the balance between time and thermal energy consumption, it is preferably 40° C. or higher, more preferably 60° C. or higher, and the upper limit is preferably 90° C. or lower, more preferably 85° C. or lower.

Redissolution may be performed while stirring. Stirring makes it possible to redissolve more quickly, and thus it is possible to improve efficiency in terms of time. However, it leads to loss of energy, and thus energy efficiency decreases. Therefore, the necessity of stirring may be determined according to requests.

In the case of stirring, the stirring time (the time required for redissolution) is not particularly limited, and may vary depending on the properties of the low-grade lithium carbonate used as the starting material, the scale of an apparatus, etc., and cannot be determined unconditionally. However, considering the balance between time and energy consumption, it is preferably 10 minutes or more, more preferably 30 minutes or more, and the upper limit is preferably 3 hours or less, more preferably 2 hours or less, and even more preferably 1.5 hours or less.

The metal removing agent added to the aqueous solution D obtained by redissolution may be appropriately selected according to the metal to be removed. For example, when the metal to be removed is potassium, which is particularly preferable in the production method of the present embodiment, hexafluorosilicic acid (H₂SiF₆) or the like can be preferably used.

The separated solid 2 obtained by the solid-liquid separation 2 contains impurities such as potassium and magnesium that can be contained in the lithium hydroxide of the separated solid 1-2.

In addition, the separated liquid 2 obtained by the solid-liquid separation 2 is an aqueous solution containing high-purity lithium hydroxide from which these impurities have been removed.

### (Cooling and Solid-Liquid Separation 3)

In the production method of the present embodiment, in the case where the method 2 is adopted to obtain high-purity lithium hydroxide from an aqueous lithium hydroxide solution, when an aqueous solution containing high-purity lithium hydroxide, which is the separated liquid 2 obtained by the solid-liquid separation 2, is cooled, the lithium hydroxide is recrystallized, and solid-liquid separation 3 is performed to obtain lithium hydroxide with high purity as the separated solid 3. Lithium hydroxide of the separated solid 3 is a product produced by the production method of the present embodiment.

The separated liquid 3 obtained by the solid-liquid separation 3 is a saturated aqueous solution containing lithium hydroxide that has not been recrystallized by the cooling. The separated liquid 3 may be used for the redissolution from the viewpoint of waste reduction. Although the separated liquid 3 is a saturated aqueous solution containing lithium hydroxide, the temperature of the separated liquid 3 naturally rises to the temperature before cooling when it is redissolved, so that lithium hydroxide can be further dissolved. Moreover, the separated liquid 3 may be heated and used as needed.

When lithium hydroxide is produced by the production method of the present embodiment, the separated solid 1-2 and the separated solid 3 obtained by performing the solid-liquid separation 1 and the solid-liquid separation 3 can be used as products. These lithium hydroxides are generally monohydrate (LiOH·H₂O). The resultant lithium hydroxide can be directly used as it is in accordance with the use thereof, or can be used after further dewatered.

In the case where monohydrate of lithium hydroxide is dewatered, it can be dried in any ordinary manner of heating or depressurization.

### (Addition of Oxalic Acid and Solid-Liquid Separation 4)

As shown in FIGS. 1 and 2, the production method of the present embodiment preferably further includes adding an oxalic acid to the aqueous organic acid lithium solution (aqueous solution A) obtained by producing the aqueous organic acid lithium solution and performing solid-liquid separation 4.

By adding an oxalic acid, it is possible to precipitate, for example, calcium and other heavy metals that are contained in the aqueous organic acid lithium solution (aqueous solution A) and that may be contained in low-grade lithium carbonate. Then, the precipitated impurities can be removed as a separated solid 4 by the solid-liquid separation 4.

The separated liquid 4 obtained by the solid-liquid separation 4 becomes an aqueous organic acid lithium solution (aqueous solution A) from which impurities are removed as the separated solid 4. Therefore, it is preferable to produce an aqueous lithium hydroxide solution by a reaction between the separated liquid 4 and a metal oxide. Since the solid-liquid separation 4 contains few impurities, lithium hydroxide with improved purity can be obtained as a result.

Also, when the lithium ion separation device of FIGS. 3 and 4 is employed, it is preferable to add, instead of an oxalic acid, an aqueous solution B (an aqueous solution containing metal hydroxide) discharged from a cathode side of an electrochemical device.

### (Addition of Carbon Dioxide and Solid-Liquid Separation 5)

As shown in FIGS. 3 and 4, the production method of the present embodiment further includes adding carbon dioxide to the recovery liquid and performing solid-liquid separation 5, and the lithium carbonate contained in a separated liquid 5 obtained by the solid-liquid separation 5 can be used to produce the aqueous organic acid lithium solution. Further, when the method 2 is employed to obtain high-purity lithium hydroxide from an aqueous lithium hydroxide solution, as shown in FIGS. 1 and 2, for the separated liquid 2, similar to the recovery liquid, addition of carbon dioxide and performing the solid-liquid separation 5 and the lithium carbonate contained in the separated liquid 5 obtained by the solid-liquid separation 5 can be used to produce the aforementioned aqueous organic acid lithium solution.

The recovery liquid and the separated liquid 2 are aqueous solutions containing lithium hydroxide with high purity, and when carbon dioxide is added thereto, lithium carbonate with high purity can be obtained. By performing the solid-liquid separation 5, lithium carbonate with high purity is obtained as the separated solid 5. Lithium carbonate of the separated solid 5 is a product produced by the production method of the present embodiment.

Carbon dioxide is preferably generated by producing an aqueous organic acid lithium solution. According to the above chemical reaction formula (1), carbon dioxide is generated by reacting lithium carbonate with an organic acid such as acetic acid. Although carbon dioxide can be discarded as it is, from the viewpoint of reducing waste, it is preferably used when producing lithium carbonate from lithium hydroxide. As shown in FIGS. 1 and 2, when the liquid 1 (an acid containing an organic acid such as acetic acid) reacts with the liquid 3 (lithium carbonate liquid) in the reaction tank 1, carbon dioxide may be added to the separated liquid 2 in the form of being contained in a mixed gas.

### [Lithium Compound Production Apparatus]

An apparatus for producing a lithium compound according to the present embodiment is a production apparatus including
a reaction tank 1, a reaction tank 2, an electrochemical device, and a return pipe,
wherein the reaction tank 1 is a tank for mixing lithium carbonate, an acid containing an organic acid, and water to produce an aqueous organic acid lithium solution,
the reaction tank 2 is a tank for mixing the aqueous organic acid lithium solution and a metal hydroxide to produce an aqueous lithium hydroxide solution,
the electrochemical device is a device for regenerating an organic acid used in producing the aqueous organic acid lithium solution from an aqueous solution obtained by removing lithium hydroxide from the aqueous lithium hydroxide solution, and
the return pipe is a pipe for returning the regenerated organic acid to the reaction tank 1.

The functions of the reaction tank 1, the reaction tank 2, and the electrochemical device, that is, the reaction tank 1 fulfilling the function of mixing and reacting lithium carbonate with an acid containing an organic acid such as acetic acid to produce an aqueous organic acid lithium solution, the reaction tank 2 fulfilling the function of mixing and reacting the aqueous organic acid lithium solution with metal hydroxide to produce an aqueous lithium hydroxide solution, and the electrochemical device fulfilling the function of regenerating an organic acid such as acetic acid used in producing the aqueous organic acid lithium solution from an aqueous solution obtained by removing lithium hydroxide from the aqueous lithium hydroxide solution, are as described in the method for producing a lithium compound according to the present embodiment.

The reaction tanks 1 and 2 are not particularly limited in form as long as they are tanks capable of performing the above reaction by mixing, and normal tank-shaped reaction tanks may be used. Moreover, in order to perform mixing in these reaction tanks, it may be a reaction tank equipped with a stirrer or a reaction tank equipped with a heating equipment as needed.

Also, the configuration of the electrochemical device is as described above in the method for producing a lithium compound of the present embodiment.

Carbon dioxide is by-produced by the reaction of mixing an organic acid such as acetic acid and lithium carbonate in the reaction tank 1, and the by-produced carbon dioxide is added to the separated liquid 2 as a mixed gas, while part of the carbon dioxide is dissolved in the aqueous solution A (aqueous organic acid lithium solution) supplied from the reaction tank 1. Carbon dioxide dissolved in the aqueous solution A becomes a factor for the production of lithium carbonate in the subsequent reaction tank 2, or in a redissolution tank when the method 2 is adopted. Lithium carbonate can be an impurity when producing lithium hydroxide in the production method of the present embodiment.

Therefore, it is preferable that the reaction tank 2 is equipped with a unit for supplying an inert gas as a unit for removing carbon dioxide in the aqueous solution. In this case, it is preferable that the inert gas supply unit is designed such that the inert gas can be supplied by bubbling.

In addition, regarding the production of lithium carbonate from carbon dioxide, it is preferable to have an inert gas supply unit that can be in the downstream of the reaction tank 2 and the redissolution tank, that is, that can make the solid-liquid separations 2, 3 and 5 in an inert gas atmosphere. Moreover, it is preferable to bubble an inert gas in the redissolution tank.

By having such a unit, in the case where lithium carbonate can become an impurity, carbon dioxide, which is a factor, can be eliminated, and thus the production of lithium carbonate can be suppressed.

### (Crystallization Device)

It is preferable that the apparatus for producing a lithium compound of the present embodiment further includes a crystallization device for crystallizing the recovery liquid. When the method 2 is adopted to obtain high-purity lithium hydroxide from an aqueous lithium hydroxide solution, it is preferable that a crystallization device for crystallizing the aqueous lithium hydroxide solution is provided. By providing a crystallization device, the purity of lithium hydroxide can be improved.

The crystallization device included in the lithium compound production apparatus of the present embodiment is as described in the lithium compound production method of the present embodiment. For example, when the method 2 is employed to obtain high-purity lithium hydroxide from an aqueous lithium hydroxide solution, as described above, in the production apparatus of the present embodiment, the reaction tank 2 can also serve as a crystallization device, and in consideration of efficiency, it is preferable that the reaction tank 2 also serves as a crystallization device. When the reaction tank 2 is equipped with a stirrer for stirring the aqueous solution B to be a mother liquor, the aqueous solution A to be dripped and the like, and a unit capable of dripping the aqueous solution A or the like, it can also serve as a crystallization device. In this case, no separate independent crystallization device is required.

The crystallization performed in the crystallization device is as described in the lithium compound production method of the present embodiment above, and there is no particular limitation on the form as long as the adopted crystallization method can be carried out. When the method 1 is adopted to obtain high-purity lithium hydroxide from an aqueous lithium hydroxide solution, it is preferable to adopt a crystallization device that can perform evaporative crystallization, and when the method 2 is adopted, it is preferable to adopt one that can perform pH crystallization.

### (Other Devices)

The production apparatus of the present embodiment needs to have a reaction tank 1, a reaction tank 2, an electrochemical device and a return pipe, and preferably has a lithium ion separation device equipped with a Li permselective membrane, and a crystallization device.

Here, the lithium ion separation device equipped with a Li permselective membrane is a device that is adopted when the method 1 is employed to obtain high-purity lithium hydroxide from an aqueous lithium hydroxide solution. The configuration of the lithium ion separation device is as described in the method for producing a lithium compound of the present embodiment. By having the lithium ion separation device, the production apparatus of the present embodiment can obtain high-purity lithium hydroxide without using chemicals, and can easily produce high-purity lithium hydroxide simply by crystallizing the recovery liquid. In this case, a crystallization device for crystallizing the recovery liquid, a solid-liquid separation device, and, if necessary, a dryer for drying and the like may be provided.

A crystallization device may be used when the method 2 is employed to obtain high-purity lithium hydroxide from an aqueous lithium hydroxide solution. Further, as shown in FIGS. 1 to 4, the production apparatus of the present embodiment may have, as devices other than these, a solid-liquid separation device capable of performing the solid-liquid separations 1 to 5, a unit for supplying an organic acid such as oxalic acid, a unit for supplying a metal removing agent, a redissolution tank for redissolving lithium hydroxide, and a unit for cooling lithium hydroxide.

These devices and the like may be provided according to a method employed in the method for producing a lithium compound of the present embodiment.

### (Storage Tank)

The production apparatus of the present embodiment may be equipped with a storage tank as needed (not shown).

For example, as mentioned above, when adopting a lithium ion separation device, there is a storage tank for storing a raw liquid and a recovery solution. By having a storage tank for the raw liquid and the recovery solution, various operations can be handled.

By providing a storage tank for the recovery liquid, it becomes easy to circulate the recovery liquid, store it until the lithium ions contained in the recovery liquid reach a predetermined concentration or higher, and control the distribution of the recovery liquid according to a required amount of lithium hydroxide and lithium carbonate that will be products. As a result, the operability of the production apparatus of the present embodiment is improved. On the other hand, by providing a storage tank for the raw liquid, it becomes easy to temporarily store the aqueous solution C, which is the raw liquid, and the Li ion-removed aqueous solution according to the circulation of the raw liquid and the operating conditions of the lithium ion separation device and the electrochemical device, thereby improving the operability of the production apparatus of the present embodiment.

In addition to the above, storage tanks for storing the liquid 2, aqueous solutions A and B, which are liquids to be supplied to the electrochemical device, for example, can also be used. Having a storage tank for storing a liquid to be supplied to the electrochemical device facilitates adjustment of the supply amount according to the operating conditions of the electrochemical device, thereby improving the operability of the production apparatus of the present embodiment.

Pure water may be supplied to the lithium ion separation device and the electrochemical device as needed; however, by supplying the pure water to a storage tank once and then supplying the same to the electrochemical device, the supply of pure water is easy to manage, and the operability of the production apparatus of the present embodiment is improved.

A storage tank for storing raw materials such as lithium carbonate, water, and organic acid may be provided.

For example, in FIGS. 1 to 4, water is shown to be supplied to a lithium carbonate line. Although low-grade lithium carbonate (crude lithium carbonate) as a raw material is supplied in the form of slurry as described above, a storage tank may be provided for adjusting the slurry. In this case, raw materials such as low-grade lithium carbonate (crude lithium carbonate) and water may be supplied, mixed in advance, and supplied to the reaction tank 1 in the form of a slurry: By providing the storage tank, it is possible to adjust the supply amount of the slurry of low-grade lithium carbonate according to the mixing state in the reaction tank 1, etc., so that the operability of the production apparatus of the present embodiment is improved.

Also, in FIGS. 1 to 4, an organic acid is shown to be directly supplied to the reaction tank 1. The organic acid is also temporarily stored in the storage tank in advance, and the supply amount of the organic acid can be adjusted according to the mixing state in the reaction tank 1, etc., so that the operability of the production apparatus of the present embodiment is improved.

### EXAMPLES

Next, the present invention will be specifically described by Examples; however, the present invention is not limited by these Examples at all.

### (Measurement of Atom Content)

After weighing a sample, dilute nitric acid (3% by mass aqueous solution) was added to dissolve the sample, and an ICP emission spectrometer (“5100 ICP-OES (model number)”, manufactured by Agilent Technologies) was used to measure the content of various atoms contained in the sample such as a lithium ion extract.

### (Purity Measurement)

The purity of lithium hydroxide was measured and calculated using a potentiometric titrator (“COM-1600 (model number)”, manufactured by Hiranuma Sangyo Co., Ltd.) after weighing lithium hydroxide obtained in Examples in a glove box (dew point: about −100° C., nitrogen atmosphere) and dissolving the lithium hydroxide in water.

### Example 1

A low-grade lithium carbonate containing elements shown in Table 1 prepared according to the following (Preparation of Low-grade Lithium Carbonate) was prepared to produce lithium hydroxide and lithium carbonate using the lithium compound production apparatus shown in FIG. 1. The purity of the resulted lithium hydroxide was 99.9%, and extremely high-purity lithium hydroxide was obtained. The operation of each step in each device and the like in the lithium compound production apparatus was carried out as follows.

### (Preparation of Low-Grade Lithium Carbonate)

Low-grade lithium carbonate, which is a starting material, was prepared by adding metals such as Ca and Mg as impurity components to lithium carbonate (commercially available), assuming that the impurity components were derived from salt water, to prepare those shown in Table 1. The purity of lithium carbonate in the low-grade lithium carbonate was 90.7% by mass.

### (Reaction Tank 1 and Oxalic Acid Treatment)

In the reaction tank 1, acetic acid was mixed with an aqueous solution containing the low-grade lithium carbonate (lithium carbonate content: 99.0 mol %) so that the molar amount was 1.1 times that of lithium carbonate to prepare a 4.72 mol/L lithium acetate solution (aqueous solution A). The Ca content contained in the lithium acetate solution (aqueous solution A) was 0.90 mol %. Then, a white solid (separated solid 4) produced by adding 1.1 times the molar amount of oxalic acid to the Ca concentration in the aqueous solution A was separated by filtration (solid-liquid separation 4). The above processing was performed at room temperature (25° C.).

Here, filtration (solid-liquid separation 4) was performed by vacuum filtration. General commercially available filter paper (“No. 5 (model number)”, manufactured by Advantech Toyo Co., Ltd.) was used as a filter paper, and filtration was performed under reduced pressure in a polypropylene container. For a pump, a desktop size diaphragm type dry vacuum pump was used. Other solid-liquid separations 1 to 3 and 5, which will be described later, were also performed by the same method as the solid-liquid separation 4.

### (Reaction Tank 2)

The mixing ratio of potassium hydroxide and lithium acetate was adjusted as follows, depending on the molar ratio of potassium to lithium (K/Li metal molar ratio). While stirring a 50% by mass aqueous solution of potassium hydroxide (aqueous solution B, mother liquor) supplied from the electrochemical device at a stirring speed of 30 rpm, the lithium acetate solution (separated liquid 4) obtained in the solid-liquid separation 4 was added dropwise until the molar ratio of potassium to lithium (K/Li metal molar ratio) reached 1.5, and then the stirring was continued for 24 hours to crystallize and age lithium hydroxide crystals.

### (Redissolution Tank and Solid-Liquid Separation 2)

In a redissolution tank, 70 ml of pure water was added to 30 g of lithium hydroxide (separated solid 1) obtained by the above crystallization and aging for redissolution to prepare 100 g of an aqueous lithium hydroxide solution. Next, hexafluorosilicic acid was added to the prepared solution (aqueous solution D) at a molar ratio of 0.5 times the potassium in the solution, and after stirring for 2 hours, the product (white solid) was separated by filtration (solid-liquid separation 2). The purified aqueous lithium hydroxide solution was allowed to stand overnight at about 10° ° C. for cooling, and the cooled solution was filtered (solid-liquid separation 3) to obtain lithium hydroxide (white crystals).

### (Electrochemical Device)

As the electrochemical device, an electrochemical device equipped with an iridium-coated titanium plate used for a positive electrode plate, which is an oxygen generating electrode, a stainless steel plate used for a negative electrode plate, and an AHO film (manufactured by Asahi Glass) used as a negative ion exchange membrane, was used. A part of the lithium acetate solution (aqueous solution A) obtained in the reaction tank 1 was supplied to an anode side, and the separated liquid 1 obtained in the reaction tank 2 (crystallization) and the solid-liquid separation 1 was supplied to a cathode side, and an electrochemical reaction was performed at a constant current of 1 A. The diaphragm layer capacity in the electrochemical device is 200 ml, and the effective electrode area is 4.0×3.0 cm².

### (Production of Lithium Carbonate)

A mixed gas containing mainly carbon dioxide (CO₂) generated in the reaction tank 1 was blown into the separated liquid 2 (aqueous lithium hydroxide solution) obtained by the solid-liquid separation 2 for 30 minutes so that the molar ratio of carbon dioxide (CO₂) was 0.5 times that of the lithium hydroxide in the separated liquid 2. Thereafter, the solution was filtered (solid-liquid separation 5) to result white crystals (lithium carbonate) as the separated solid 5. The obtained lithium carbonate had a purity of 99.5% and a yield of 30%.

### Example 2

Lithium carbonate was obtained in the same manner as in Example 1 except that the lithium acetate solution (separated liquid 4) was added dropwise for crystallization in the reaction tank 2 in Example 1 until the molar ratio of potassium to lithium (K/Li metal molar ratio) reached 2.5. The obtained lithium carbonate had a purity of 99.5% and a yield of 45%.

TABLE 1

| | Content |
|---|---|
| Metal type | Mass ppm |
| Li | 184,155 |
| B | 156 |
| Na | 1,331 |
| Mg | 924 |
| Al | 8 |
| K | 493 |
| Ca | 3,138 |
| Zn | 1 |
| Pb | 2 |
| Cl | 1,438 |
| SO₄ | 630 |

### Example 3

Using the apparatus for producing a lithium compound shown in FIG. 3, the aqueous lithium hydroxide solution obtained in the reaction tank 2 was supplied to a lithium ion separation device as follows.

In the reaction tank 2 containing 200 mL of a lithium acetate battery material chamber solution (separated liquid 4) obtained in the solid-liquid separation 4 in Example 1, 5M aqueous sodium hydroxide solution (aqueous solution B, mother liquor) was added dropwise while stirring at a stirring speed of 30 rpm until the pH reached 13 to obtain an aqueous lithium hydroxide solution containing lithium ions.

The obtained aqueous solution C was put into the raw liquid tank as a raw liquid, and the 0.1M aqueous lithium hydroxide solution was put in the recovery liquid tank as a recovery liquid. A voltage of 5 V was applied between both electrodes to recover Li ions in the recovery liquid.

Evaporative crystallization was performed on the recovery liquid from which Li ions were recovered after voltage application for 240 hours.

X-ray diffraction (XRD) measurement of the precipitated solid content confirmed that only lithium hydroxide monohydrate was produced (purity: 99.9%).

### Example 4

In Example 3, an electrochemical device equipped with a positive ion exchange membrane was used, 200 mL of a Li ion-removed aqueous solution after recovering lithium ions was placed in an anode tank of the electrochemical device, and 200 mL of 0.1 M aqueous sodium hydroxide solution was placed in a cathode tank. An electrochemical reaction was performed for 24 hours at a constant current of 1 A. The concentrations of sodium in the aqueous sodium hydroxide solution introduced into the cathode side before and after the electrochemical reaction were 0.1M and 3.5M, respectively. The lithium compound production apparatus used in Example 4 is shown in FIG. 4.

When the aqueous solution on the cathode side after the above electrochemical reaction was supplied to the reaction tank 2 as the aqueous solution B, the pH in the reaction tank 2 became 13.2. The aqueous solution in the reaction tank 2 was supplied to a lithium ion separation device, and a voltage of 5 V was applied between both electrodes for 24 hours to recover lithium ions in a recovery liquid and evaporative crystallization was performed. X-ray diffraction (XRD) measurement of the precipitated solid content confirmed that only lithium hydroxide monohydrate was produced (purity: 99.9%).

From the results of Examples 3 and 4 above, it was confirmed that high-purity lithium hydroxide can be obtained regardless of whether a negative ion exchange membrane or a positive ion exchange membrane is used as the ion exchange membrane provided in the electrochemical device.

### Preparation Example 1

In the reaction tank 1, the aqueous solution containing low-grade lithium carbonate (lithium carbonate content: 99.0 mol %) used in Example 1 was mixed with formic acid so that the molar amount of the formic acid was 1.1 times that of lithium carbonate to prepare a 4.72 mol/L lithium formate solution.

### Preparation Example 2

In the reaction tank 1, the aqueous solution containing low-grade lithium carbonate (lithium carbonate content: 99.0 mol %) used in Example 1 was mixed with citric acid so that the molar amount of the citric acid was 1.1 times that of lithium carbonate to prepare a 4.72 mol/L lithium citrate solution.

### Reference Example 1

An aqueous solution of sodium hydroxide (sodium hydroxide concentration: 1 mol %) was added to the lithium acetate solution (4.7 mol %) used in the reaction tank 1 of Example 1 so that the amount of Na was 1.5 times the amount (mol) of lithium contained in the organic acid lithium solution, and the resultant aqueous solution was subjected to evaporative crystallization.

The precipitated salt was subjected to solid-liquid separation by filtration, and the powder sample after evaporative drying of the separated liquid was subjected to X-ray diffraction (XRD) measurement. As a result, it was confirmed that lithium hydroxide monohydrate was produced.

### Example 5

Regarding the lithium formate solution obtained in Preparation Example 1, the salt obtained in the same manner as in Reference Example 1 above was subjected to solid-liquid separation by filtration, and the powder sample after evaporative drying of the separated liquid was subjected to X-ray diffraction (XRD) measurement. As a result, it was confirmed that lithium hydroxide monohydrate was produced.

Therefore, it is considered that, even when formic acid is used as the organic acid, high-purity lithium hydroxide can be obtained in the same manner as acetic acid.

It was confirmed from the Examples that a high-purity lithium compound can be efficiently produced from low-grade lithium carbonate containing impurities such as salt water, according to the lithium compound production method and production apparatus of the present embodiment. In addition, it was found that formic acid, oxalic acid, and citric acid, like acetic acid, can be used as organic acids to efficiently produce a high-purity lithium compound.

1. A method for producing a lithium compound, comprising:
mixing lithium carbonate, an acid containing an organic acid, and water in a reaction tank 1 to produce an aqueous organic acid lithium solution containing an organic acid lithium,
mixing the organic acid lithium and a metal hydroxide in a reaction tank 2 to produce an aqueous lithium hydroxide solution, and
returning an organic acid, which is regenerated by using an electrochemical device from an organic acid metal by-produced by producing the aqueous lithium hydroxide solution, to the reaction tank 1, and using the regenerated organic acid as the organic acid.

2. The method for producing a lithium compound according to claim 1, wherein the metal hydroxide is regenerated by the electrochemical device and returned to the reaction tank 2.

3. The method for producing a lithium compound according to claim 1, further comprising:
recovering only lithium ions from the aqueous lithium hydroxide solution into a recovery liquid using a lithium ion separation device equipped with a Li permselective membrane.

4. The method for producing a lithium compound according to claim 3, further comprising:
crystallizing the recovery liquid recovered using the lithium ion separation device and performing a solid-liquid separation 1.

5. The method for producing a lithium compound according to claim 3, wherein the organic acid metal is supplied to the electrochemical device by a Li ion-removed aqueous solution obtained by recovering only lithium ions from the aqueous lithium hydroxide solution to the recovery liquid using the lithium ion separation device equipped with a Li permselective membrane.

6. The method for producing a lithium compound according to claim 1, further comprising:
adding an oxalic acid to the aqueous organic acid lithium solution and performing a solid-liquid separation 4.

7. The method for producing a lithium compound according to claim 6, wherein the aqueous lithium hydroxide solution is produced by reacting a separated liquid 4 obtained by the solid-liquid separation 4 with the metal hydroxide.

8. The method for producing a lithium compound according to claim 3, further comprising:
adding carbon dioxide to the recovery liquid and performing a solid-liquid separation 5,
wherein lithium carbonate contained in a separated liquid 5 obtained by performing the solid-liquid separation 5 is used to produce the aqueous organic acid lithium solution.

9. The method for producing a lithium compound according to claim 8, wherein the carbon dioxide is generated by producing the aqueous organic acid lithium solution.

10. The method for producing a lithium compound according to claim 4, wherein lithium hydroxide is obtained by performing the solid-liquid separation 1.

11. The method for producing a lithium compound according to claim 8, wherein lithium carbonate is obtained by performing the solid-liquid separation 5.

12. The method for producing a lithium compound according to claim 1, wherein a metal forming the metal hydroxide and a metal forming the organic acid metal are the same.

13. The method for producing a lithium compound according to claim 1, wherein the metal is at least one selected from sodium, potassium, and barium.

14. An apparatus for producing a lithium compound, comprising:
a reaction tank 1,
a reaction tank 2,
an electrochemical device, and
a return pipe,
wherein the reaction tank 1 is a tank for mixing lithium carbonate, an acid containing an organic acid, and water to produce an aqueous organic acid lithium solution,
the reaction tank 2 is a tank for mixing the aqueous organic acid lithium solution and a metal hydroxide to produce an aqueous lithium hydroxide solution,
the electrochemical device is a device for regenerating an organic acid, the organic acid is suitable for producing the aqueous organic acid lithium solution from an aqueous solution obtained by removing lithium hydroxide from the aqueous lithium hydroxide solution, and
the return pipe is a pipe for returning the regenerated organic acid to the reaction tank 1.

15. The apparatus for producing a lithium compound according to claim 14, further comprising:
a lithium ion separation device equipped with a Li permselective membrane that recovers only lithium ions from the aqueous lithium hydroxide solution into a recovery liquid.

16. The apparatus for producing a lithium compound according to claim 15, further comprising:
a crystallization device that crystallizes the recovery liquid.
